(19) United States
(12) Patent Application Publication
(10) Pub. No.: US 2026/0346925 A1
(43) Pub. Date: Nov. 5, 2026

(54) CARGO BOX ASSEMBLY FOR AN OFF-ROAD VEHICLE

(71) Applicant: BOMBARDIER RECREATIONAL PRODUCTS INC., Valcourt (CA)

(72) Inventors: Charles DESPRÉS-NADEAU, Sherbrooke (CA); Catherine GEOFFROY, Granby (CA); Francis GENDRON, Sherbrooke (CA)

(73) Assignee: BOMBARDIER RECREATIONAL PRODUCTS INC., Valcourt (CA)

(21) Appl. No.: 19/403,136

(22) Filed: Nov. 27, 2025

Related U.S. Application Data
(60) Provisional application No. 63/727,339, filed on Dec. 3, 2024.
(60) Provisional application No. 63/764,681, filed on Feb. 28, 2025.

(51) Int. Cl. B62D 33/023

(52) U.S. Cl. CPC B62D 33/023

(57) ABSTRACT

The present disclosure generally relates to cargo box assemblies for off-road vehicles, specifically to cargo box assemblies that can be engaged and disengaged without necessitating additional tools and/or implements. A cargo box for an off-road vehicle, the cargo box comprising a cargo bed and a front wall configured for removable engagement with the cargo bed, the cargo box being configurable in: a first configuration comprising the cargo bed, the front wall, two side walls and a tailgate; and a second, flat-bed, configuration comprising the cargo bed.

### CROSS-REFERENCE

The present application claims the benefit of United States Provisional Patent Applications Ser. No. 63/727,339 filed on Dec. 3, 2024 and Ser. No. 63/764,681 filed on Feb. 28, 2025, the content of which are herein incorporated by reference in their entireties.

### TECHNICAL FIELD

The present disclosure generally relates to cargo box assemblies for off-road vehicles, specifically to cargo box assemblies that can be engaged and disengaged without necessitating additional tools and/or implements.

### BACKGROUND

All-terrain vehicles (ATVs) commonly have four wheels and a straddle seat adapted to accommodate a driver of the vehicle. For some utilitarian uses (e.g., to provide additional storage space, additional traction and the likes), some ATVs have six wheels (in which case they are typically referred to as 6×6 vehicles or 6×6 ATVs).

6×6 ATVs typically comprise a cargo box disposed over two pairs of rear wheels, behind an operator seat, the cargo box comprising a floor, side walls, a front wall and a tailgate. Some cargo boxes may be reconfigurable (i.e., the tailgate may be kept opened or closed, some of the front and side walls may be removed, etc.).

The cargo box of the 6×6 ATVs, including its front and side walls, is typically fastened to the frame of the vehicle. This is unpractical when the user of the vehicle wants to change the configuration of the cargo box (i.e. the user of the vehicle wants to add or remove some of the front and side walls).

Accordingly, there remains a need to provide a cargo box for a 6×6 ATVs that alleviates at least some of the problems and shortcomings discussed above.

### BRIEF DESCRIPTION OF THE DRAWINGS

The accompanying drawings illustrate an embodiment of the present disclosure and, together with the description, serve to illustrate the principles of the present disclosure.

FIG. 1 shows a front perspective view of an off-road vehicle having a cargo box, in accordance with an embodiment;

FIG. 2 shows a rear perspective view of the off-road vehicle of FIG. 1, in accordance with an embodiment;

FIG. 3A shows a front perspective view of the cargo box of FIG. 1 and having a cargo bed, a front wall, a tailgate, a left side wall and a right side wall, in accordance with an embodiment;

FIG. 3B shows a rear perspective view of the cargo box of FIG. 1, in accordance with an embodiment;

FIG. 4 shows a front view of the cargo box of FIG. 1, in accordance with an embodiment;

FIG. 5 shows a rear view of the cargo box of FIG. 1, in accordance with an embodiment;

FIG. 6 shows a left view of the cargo box of FIG. 1, in accordance with an embodiment;

FIG. 7 shows a right view of the cargo box of FIG. 1, in accordance with an embodiment;

FIG. 8 shows a top view of the cargo box of FIG. 1, in accordance with an embodiment;

FIG. 9 shows a bottom view of the cargo box of FIG. 1, in accordance with an embodiment;

FIG. 10 shows a rear perspective view of the cargo bed of FIG. 3A, in accordance with an embodiment;

FIG. 11 shows a front view of the cargo bed of FIG. 3A, in accordance with an embodiment;

FIG. 12 shows a rear view of the cargo bed of FIG. 3A, in accordance with an embodiment;

FIG. 13 shows a right view of the cargo bed of FIG. 3A, in accordance with an embodiment;

FIG. 14 shows a top view of the cargo bed of FIG. 3A, in accordance with an embodiment;

FIG. 15 shows a bottom view of the cargo bed of FIG. 3A, in accordance with an embodiment;

FIG. 16 shows a front view of the front wall of FIG. 3A having left and right latch assembly, in accordance with an embodiment;

FIG. 17A shows a front isometric view of the front wall of FIG. 3A, in accordance with an embodiment;

FIG. 17B shows an enlarged front isometric view of a front wall engaged to a cargo box, in accordance with another embodiment;

FIG. 18 shows a rear view of the front wall of FIG. 3A, in accordance with an embodiment;

FIG. 19 shows a right view of the right side wall of FIG. 3A, in accordance with an embodiment;

FIG. 20 shows a left view of the right side wall of FIG. 3A, in accordance with an embodiment;

FIG. 21 shows a front view of the right side wall of FIG. 3A, in accordance with an embodiment;

FIG. 22 shows a front isometric view of the right side wall of FIG. 3A, in accordance with an embodiment;

FIG. 23 shows a left side cutaway and enlarged isometric view of the cargo box of FIG. 3A, showing the left latch assembly element of FIG. 16 and a hook element, in accordance with an embodiment;

FIGS. 24 to 26 show first, second and third isometric views of the left latch assembly of FIG. 16, in accordance with an embodiment;

FIG. 27 shows a front enlarged isometric view of the cargo box of FIG. 3, showing the front wall and the left side wall, in accordance with an embodiment;

FIG. 28 shows a front enlarged isometric view of a second step of a method for disengaging the left side wall of FIG. 27 from the cargo box, in accordance with an embodiment;

FIG. 29 shows a left side enlarged view of a third step of a method for disengaging the left side wall of FIG. 27 from the cargo box, in accordance with an embodiment;

FIG. 30 shows a left side enlarged view of a fourth step of a method for disengaging the left side wall of FIG. 27 from the cargo box, in accordance with an embodiment;

FIG. 31 shows a left side enlarged view of a first step of a method for engaging the left side wall of FIG. 27 with the cargo box, in accordance with an embodiment;

FIG. 32 shows a front enlarged isometric view of a second step of a method for engaging the left side wall of FIG. 27 with the cargo box, in accordance with an embodiment;

FIG. 33 shows a rear perspective view of the cargo bed of FIG. 3A and a support structure thereof, in accordance with an embodiment;

FIG. 34 shows a front view of the cargo bed of FIG. 3A and the support structure thereof, in accordance with an embodiment;

FIG. 35 shows a right view of the cargo bed of FIG. 3A and the support structure thereof, in accordance with an embodiment;

FIG. 36 shows a top view of the cargo bed of FIG. 3A and the support structure thereof, in accordance with an embodiment;

FIG. 37 shows a bottom view of the cargo bed of FIG. 3A and the support structure thereof, in accordance with an embodiment;

FIG. 38 shows a front view of a front wall, in accordance with another embodiment;

FIG. 39 shows a front isometric view of the front wall of FIG. 38, in accordance with an embodiment;

FIG. 40 shows a rear view of the front wall of FIG. 38, in accordance with an embodiment;

FIG. 41 shows a rear isometric view of the front wall of FIG. 38, in accordance with an embodiment;

FIG. 42 shows a bottom isometric view of the front wall of FIG. 38, in accordance with an embodiment;

FIG. 43 shows a bottom view of the front wall of FIG. 38, in accordance with an embodiment;

FIG. 44 shows a top view of the front wall of FIG. 38, in accordance with an embodiment;

FIG. 45 shows a left view of the front wall of FIG. 38, in accordance with an embodiment;

FIG. 46 shows a side perspective view of a bolt connector for use with the front wall of FIG. 38, in accordance with an embodiment;

FIG. 47 shows a side perspective view of a latch for attachment of the front wall of FIG. 38 to the cargo bed of FIG. 3;

FIG. 48 shows a left side view of the off-road vehicle of FIG. 1 with the cargo box in an operational (or horizontal) configuration, in accordance with an embodiment; and

FIG. 49 shows a left side view of the off-road vehicle of FIG. 1 with the cargo box in a release (or angled) configuration, in accordance with an embodiment.

It is understood that the drawings are for illustration only and are only intended to depict an embodiment of the present disclosure and therefore should not be considered as limiting.

### SUMMARY

In accordance with a broad aspect, there is provided a cargo box for an off-road vehicle, the cargo box comprising a cargo bed and a front wall configured for removable engagement with the cargo bed. The cargo box being configurable in a first configuration comprising the cargo bed, the front wall, two side walls and a tailgate; and a second, flat-bed, configuration comprising the cargo bed.

In accordance with an embodiment, the front wall is configured for removable engagement with the cargo bed via a plurality of removable fasteners.

In accordance with an embodiment, the front wall is configured for removable engagement with the cargo bed via at least 4 removable fasteners.

In accordance with an embodiment, the front wall is configured for removable engagement with the cargo bed via at least 6 removable fasteners.

In accordance with an embodiment, the front wall is configured for removable engagement with the cargo bed via no more than 8 removable fasteners.

In accordance with an embodiment, the front wall comprises a central section, two lateral sections and two intermediate sections extending between the central section and respective one of the two lateral sections. The central section and each one of the two lateral sections are each configured for removable engagement with the cargo bed via at least one removable fastener.

In accordance with an embodiment, the central section and each one of the two lateral sections of the front wall are each configured for removable engagement with the cargo bed via two removable fasteners.

In accordance with an embodiment, the removable fasteners are bolts.

In accordance with an embodiment, the removable fasteners spring-loaded ball lock pins.

In accordance with an embodiment, the front wall is configured for toolless removable engagement with the cargo bed.

In accordance with an embodiment, the cargo box further comprises a first latch assembly.

In accordance with an embodiment, the front wall comprises two lateral sections, each one of the two lateral sections comprising a first latch configured for attachment with the cargo bed.

In accordance with an embodiment, the cargo bed comprises a plurality of front apertures generally positioned along a front portion of the cargo bed. The plurality of front apertures are laterally spaced apart from each other on the front portion and at least one of the plurality of front apertures is longitudinally spaced apart from remaining one of the plurality of front apertures on the front portion.

In accordance with an embodiment, a lower surface of the front wall comprises a plurality of cleats configured for removable engagement with the plurality of front apertures of the cargo bed.

In accordance with an embodiment, the two side walls are configured for removable engagement with the cargo bed.

In accordance with an embodiment, the two side walls are configured for removable engagement with the front wall.

In accordance with an embodiment, the cargo box further comprises a second latch assembly.

In accordance with an embodiment, the second latch assembly comprises a handle, a second latch and a hook element.

In accordance with an embodiment, the second latch is configured to engage the hook element.

In accordance with an embodiment, the handle is operable by a user to disengage the hook element from the second latch.

In accordance with an embodiment, the front wall comprises the handle and the second latch and the side wall comprises the hook element.

In accordance with an embodiment, the handle and the second latch are in an upper portion of the front wall.

In accordance with an embodiment, the hook element is in an upper portion of the side wall.

In accordance with an embodiment, the front wall comprises the hook element and the side wall comprises the handle and the second latch.

In accordance with an embodiment, the handle and the second latch are in an upper portion of the side wall.

In accordance with an embodiment, the hook element is in an upper portion of the front wall.

In accordance with an embodiment, the tailgate is configured for removable engagement with the side wall and the cargo bed.

In accordance with an embodiment, the tailgate is removably engageable with the side wall via a hinge.

In accordance with an embodiment, at least one of the two side walls comprises a top surface with a plurality of apertures, the apertures being configured to receive accessories.

In accordance with an embodiment, the cargo box is positioned behind an operator space of the off-road vehicle.

In accordance with an embodiment, the cargo box is positioned behind a seat of the off-road vehicle.

In accordance with an embodiment, the off-road vehicle is an ATV.

In accordance with an embodiment, the off-road vehicle is an SSV.

In accordance with another broad aspect, there is provided a method for attaching a front wall to a cargo bed of a cargo box. The front wall is configured for removable engagement with the cargo bed via a plurality of removable fasteners. The cargo bed comprises a plurality of front apertures generally positioned along a front portion of the cargo bed. A lower surface of the front wall comprises a plurality of cleats configured for removable engagement with the plurality of front apertures of the cargo bed. The method comprises: aligning along a longitudinal direction and along a lateral direction the plurality of cleats of the front wall with the plurality of front apertures of the cargo bed, engaging the plurality of cleats of the front wall with the plurality of front apertures of the cargo bed by exerting a normal downward motion onto the front wall relative to the cargo bed, and engaging the plurality of removeable fasteners with a first corresponding plurality of recesses of the front wall and a second plurality of recesses of the cargo bed.

In accordance with another broad aspect, there is provided a method for removing a front wall from a cargo bed of a cargo box. The front wall is configured for removable engagement with the cargo bed via a plurality of removable fasteners. The cargo bed comprises a plurality of front apertures generally positioned along a front portion of the cargo bed. A lower surface of the front wall comprises a plurality of cleats configured for removable engagement with the plurality of front apertures of the cargo bed. The method comprises: removing the plurality of fasteners from a first corresponding plurality of recesses of the front wall and a second plurality of recesses of the cargo bed; and disengaging the plurality of cleats of the front wall from the plurality of front apertures of the cargo bed by exerting a normal upward motion onto the front wall relative to the cargo bed.

### DETAILED DESCRIPTION

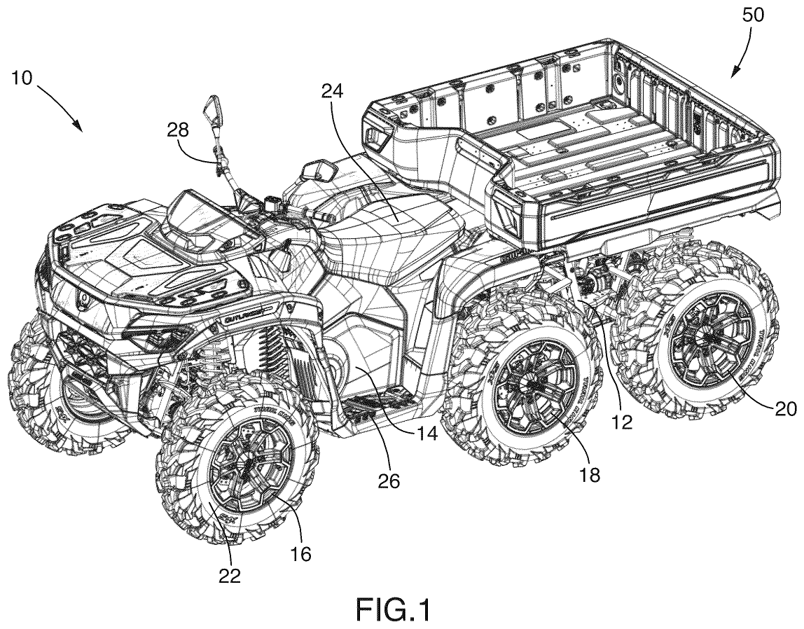

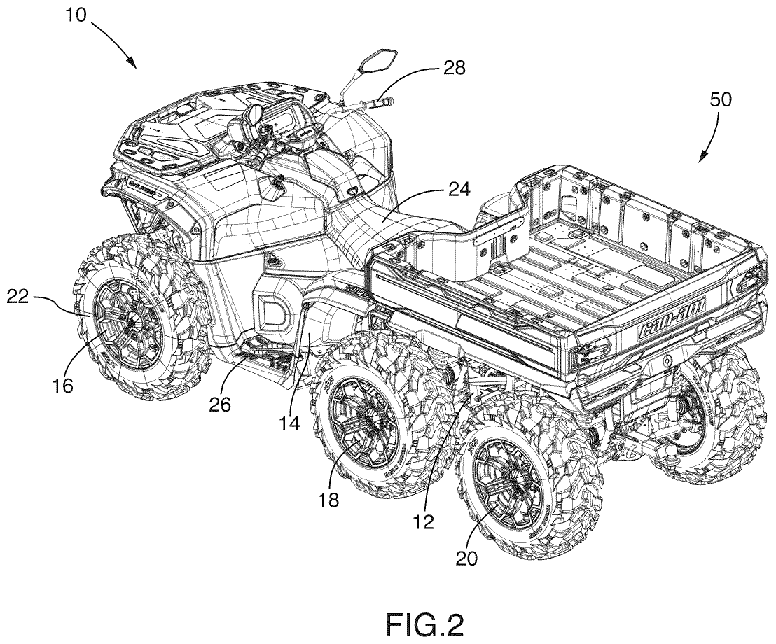

In one embodiment, and with reference to FIGS. 1 and 2, there is provided an off-road vehicle 10 having one or more straddle seats and a plurality of wheels, as further described below. In a non-limiting example, the off-road vehicle is an all-terrain vehicle (also referred-to as “ATV”) having six wheels. However, it will be readily appreciated that at least some aspects of the present disclosure could be used on ATVs having any other suitable number of wheels (e.g., 4 wheels) as well as other types of off-road vehicles having six wheels, such as, for example, side-by-side vehicles (also referred to as SSV or UTV).

In the embodiment of FIGS. 1 and 2, the off-road vehicle 10 has a frame 12 to which a vehicle body 14 is mounted. Two front wheels 16 are suspended from a front of the frame 12. Two intermediate wheels 18 are suspended from the frame 12 rearward of the front wheels 16 (along a longitudinal direction of the off-road vehicle 10). Two rear wheels 20 are suspended from the frame 12 rearward of the intermediate wheels 18 (along a longitudinal direction of the off-road vehicle 10). In this embodiment, the longitudinal distance between the intermediate and rear wheels 18, 20 is less than the longitudinal distance between the front and intermediate wheels 16, 18. Each of the six wheels 16, 18, 20 of the off-road vehicle 10 has a tire 22. A straddle seat 24 is mounted on the frame 12 to accommodate a driver of the off-road vehicle 10 and at least a portion of the seat 24 is disposed between the front wheels 16 and the intermediate wheels 18 in a longitudinal direction of the off-road vehicle 10. Foot rests 26 are provided on either side of seat 24 below the seat 24. Each foot rest 26 is disposed longitudinally between the front wheel 16 and the intermediate wheel 18 on the respective side of the off-road vehicle 10.

A steering assembly including a handlebar 28 is disposed forwardly of the straddle seat 24. A throttle lever and a brake lever (not shown) are mounted to the handlebar 28. The steering assembly is operatively connected to the two front wheels 16 to permit steering of the off-road vehicle 10. A motor (not shown) is mounted to the frame 12 below the straddle seat 22. In some non-limiting examples, the motor is a four-stroke, dual cylinder, V-type, internal combustion engine (ICE), however any other suitable motor could be used in other non-limiting examples such as, but not limited to, a two-stroke ICE, a diesel engine, an electric motor and the likes. The motor is operatively connected to the six wheels 16, 18, 20 to power the off-road vehicle 10. A gear selection lever (not shown) is provided below the handlebar 28 forward of the seat 24. A fuel filler cap (not shown) is provided on the vehicle body 14 to a right of a rear portion of the seat 24. Still in this embodiment, a cargo box 50 is mounted to the frame 12 of the off-road vehicle 10 rearward of the straddle seat 24, as further described below.

The off-road vehicle 10 has other features and components common to most off-road vehicles such as headlights, a fuel tank, an air intake system and an exhaust system. As it is believed that these features and components would be readily recognized by one of ordinary skill in the art, further explanation and description of these components will not be provided herein. Regarding the frame, suspension system as well as drive and gear assemblies of the off-road vehicle 10, these frames, systems and assemblies are similar to the ones shown and described in U.S. Pat. No. 9,555,702, issued Jan. 31, 2017, which is incorporated herein by reference.

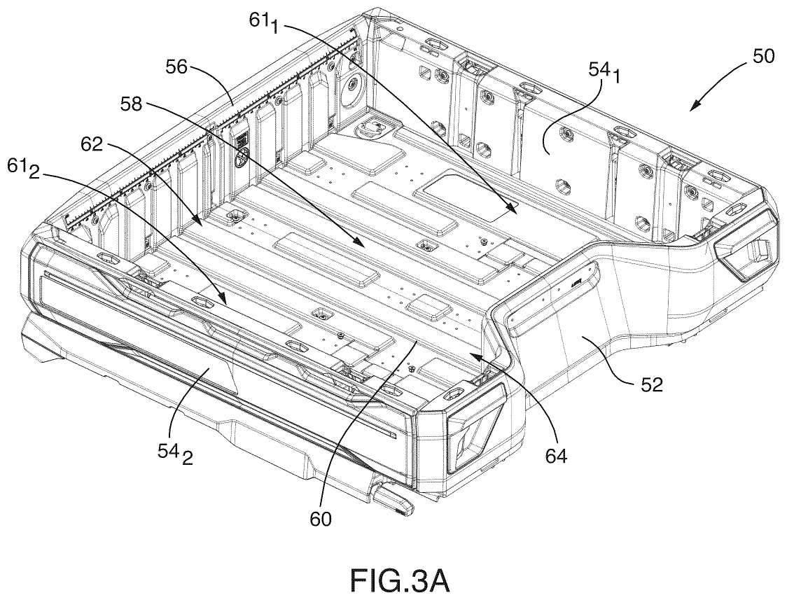

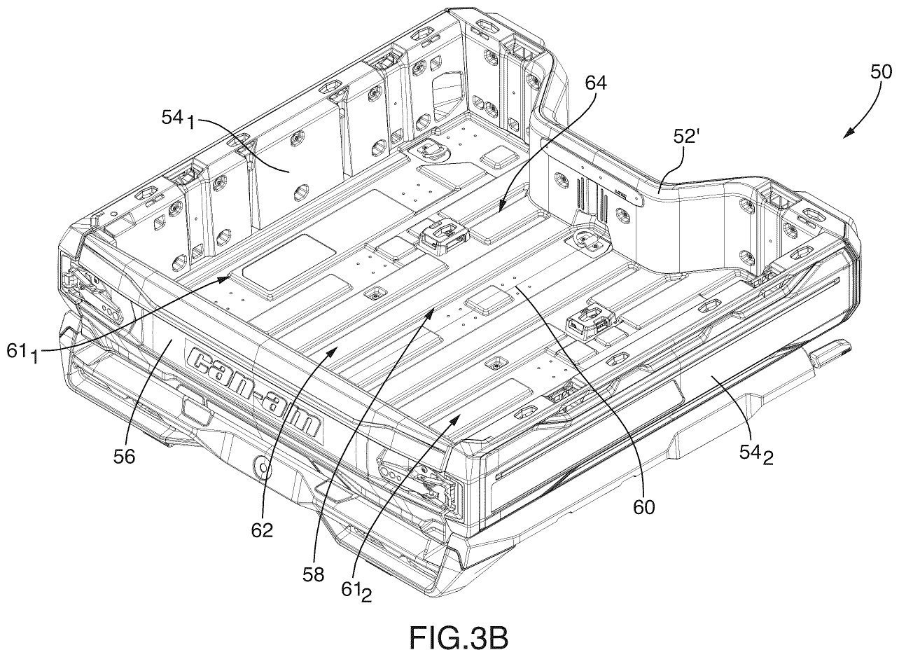

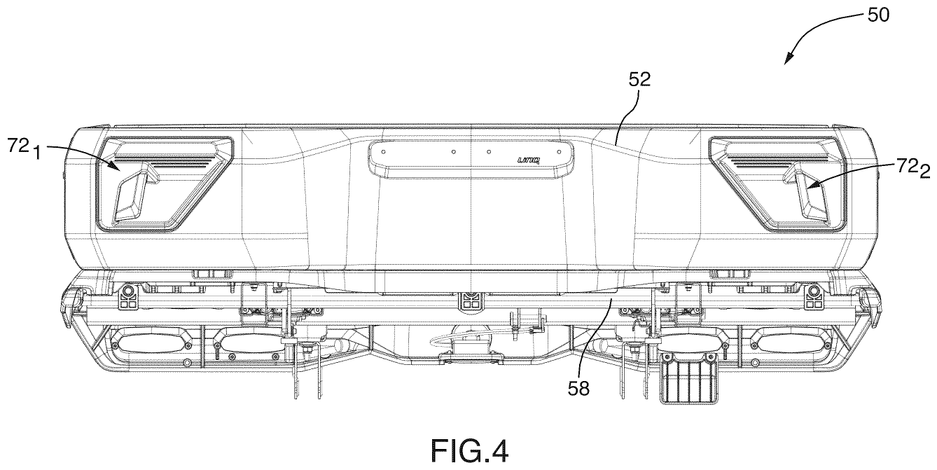

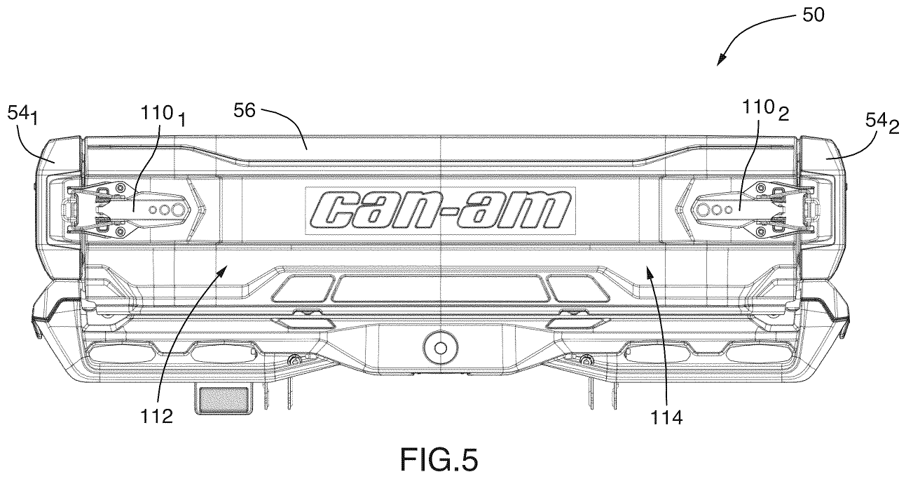

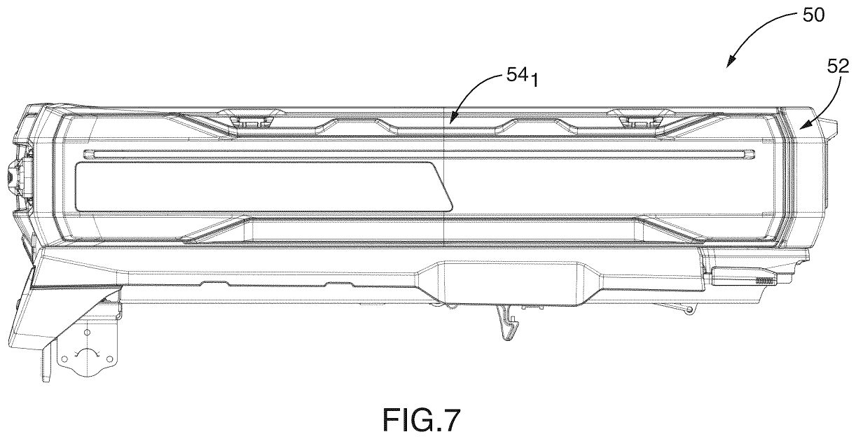

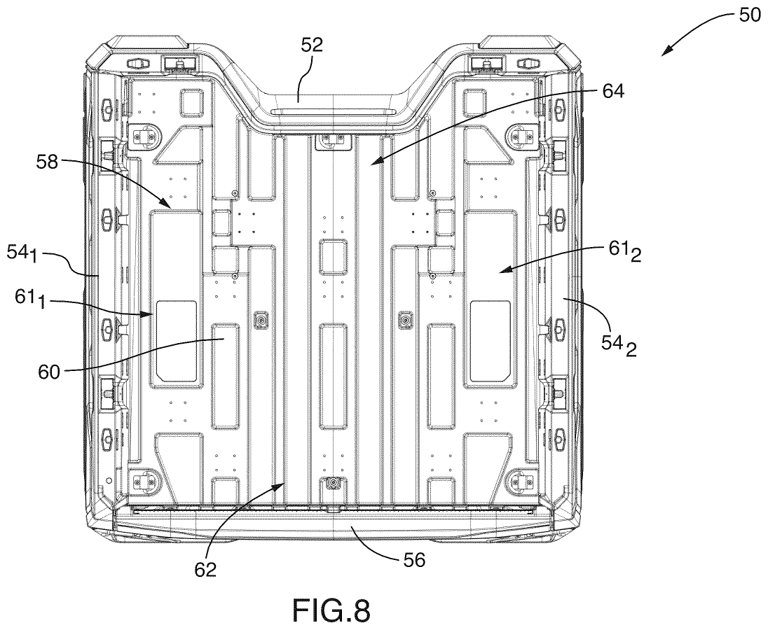

With further reference to FIGS. 3 to 9, the cargo box 50 comprises a plurality of walls, including a front wall 52 (which generally extends along a front edge of the cargo box 50), two side walls 54₁, 54₂ (also referred to as lateral walls 54₁, 54₂ which generally extend along respective lateral edges of the cargo box 50—the lateral wall 54₁ is a left side/lateral wall and the lateral wall 54₂ is a right side/lateral wall) as well as a tailgate 56 (which generally extends along a rear edge of the cargo box 50) and a cargo bed 58 (also referred to as cargo floor). The cargo box 50 (or the cargo floor 58) can accordingly be characterized by a longitudinal direction (generally extending between—and perpendicular to—the rear and the front edges of the cargo box 50/cargo bed 58) and a lateral direction (generally extending between—and perpendicular to—the left and side edges of the cargo box 50/cargo bed 58).

In some non-limiting examples, the cargo box 50 has a length (along the longitudinal direction of the cargo box 50) of between about 1100 mm and 1300 mm, including about 1215 mm, a width (along the lateral direction of the cargo box 50) of between about 1100 mm and 1300 mm, including about 1215 mm and a height (along a vertical direction of the cargo box 50) of between about 250 mm and 300 mm, including about 270 mm. It will be readily appreciated that the cargo box 50 may have a generally square shape, although this needs not be the case in other non-limiting examples (e.g., the carbo box 50 may also have a generally rectangular shape).

As further described below, the cargo box 50 comprises a first connection mechanism with a plurality of elements present on the side walls 54₁, 54₂, the cargo bed 58 and the front wall 52. This first connection mechanism with elements present on various components of the cargo box 50 enables the side walls 54₁, 54₂ of the cargo box 50 to be removably engageable with the cargo box 50 without necessitating the use of any tools or implements (i.e., the side walls 54₁, 54₂ of the cargo box 50 are toollessly engageable with and removable from the cargo box 50). In addition, in this embodiment the side walls 54₁, 54₂ and the front wall 52 of the cargo box 50 need not be fastened to the frame 12 of the off-road vehicle 10 using traditional fastening means. As further described below, the first connection mechanism comprises a plurality of cleats present on a bottom surface of the side walls 54₁₋₂ and corresponding lateral apertures positioned longitudinally along lateral side portions of the cargo bed 58, as well as latch assemblies.

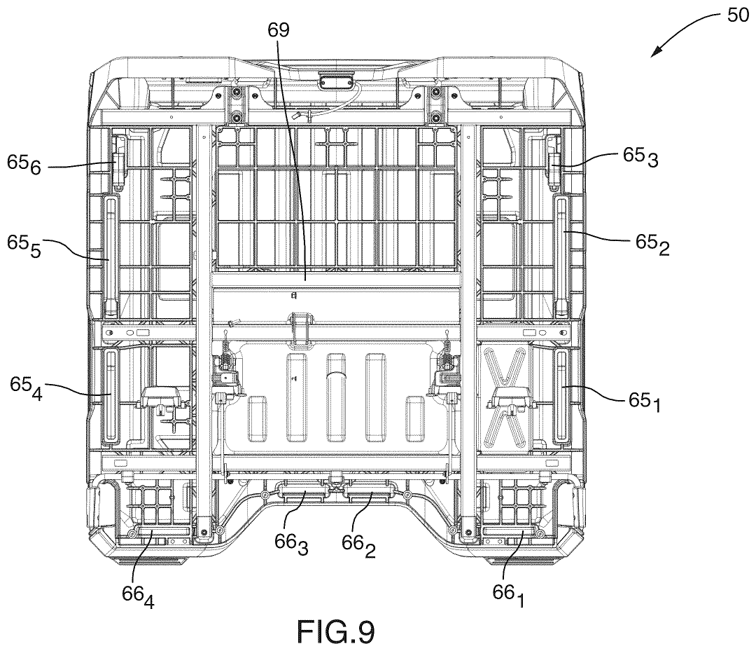

The cargo bed 58 is affixed to a support structure 100 of the cargo box 50. The support structure 100 of the cargo box 50 comprises a plurality of frame elements such as, but not limited to, square beams 69 and the likes (as shown in FIG. 9). The support structure 100 of the cargo box 50 is itself connected to the frame 12 of the off-road vehicle 10. In some non-limiting examples, the support structure 100 of the cargo box 50 is selectively pivotable relative to the frame 12 of the off-road vehicle 10, for example as described in U.S. Pat. No. 9,555,702. In further non-limiting examples, the support structure 100 of the cargo box 50 may be affixed to the frame 12 of the off-road vehicle 10 (i.e., the support structure 100 of the cargo box 50 is not selectively pivotable relative to the frame 12 of the off-road vehicle 10).

In this embodiment, the upper surface 60 of the cargo bed 58 is generally configured to be removably engageable with the front wall 52 (specifically, with a lower surface 71 of the front wall 52) and with the lateral walls 54₁, 54₂ (specifically, with a lower surface 55 of the lateral walls 54₁, 54₂).

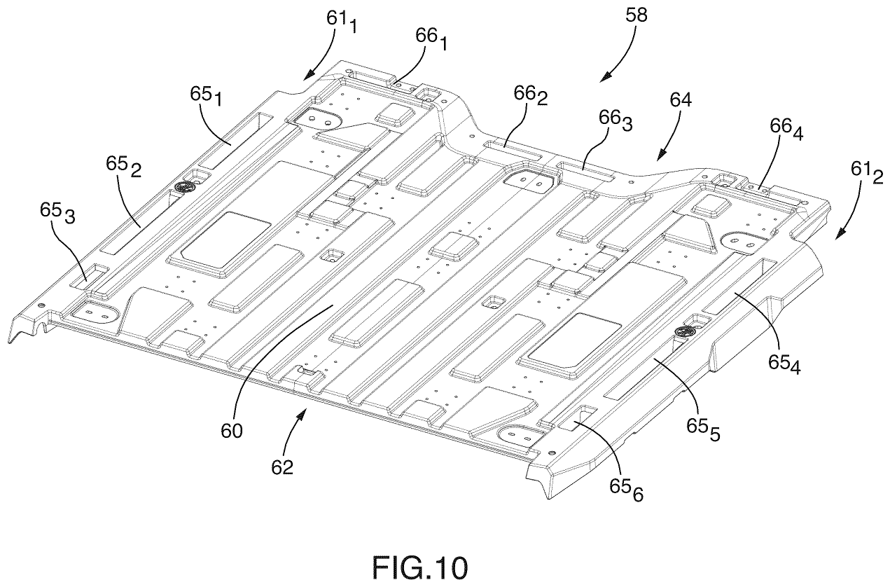

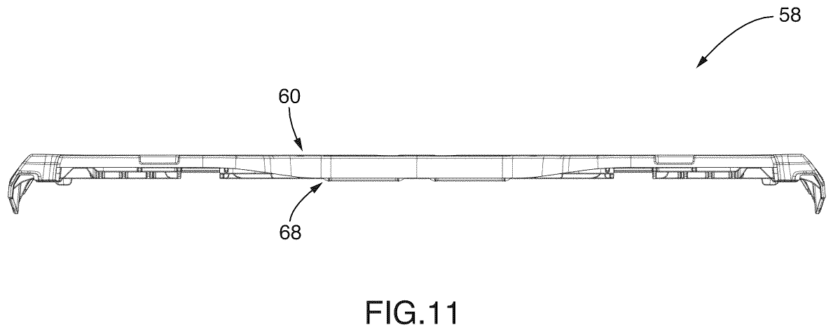

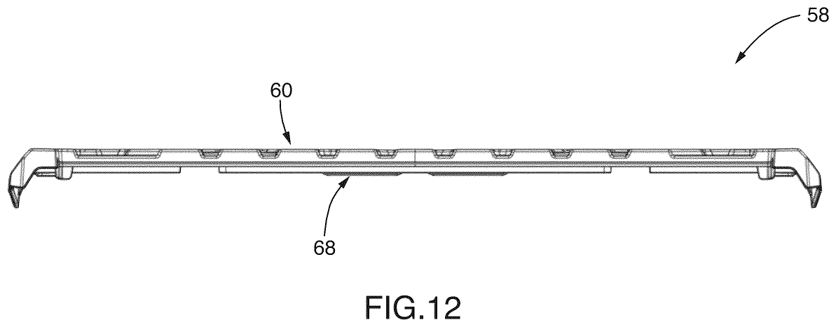

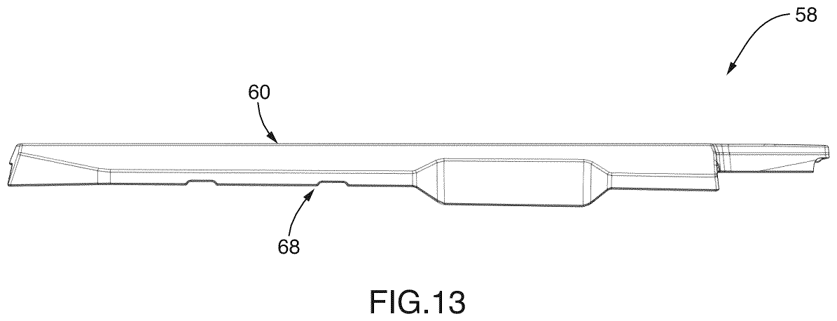

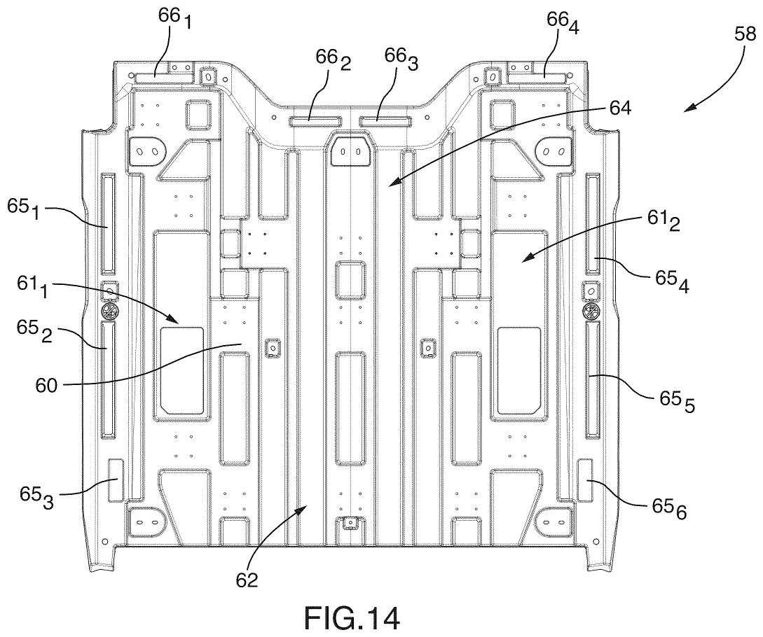

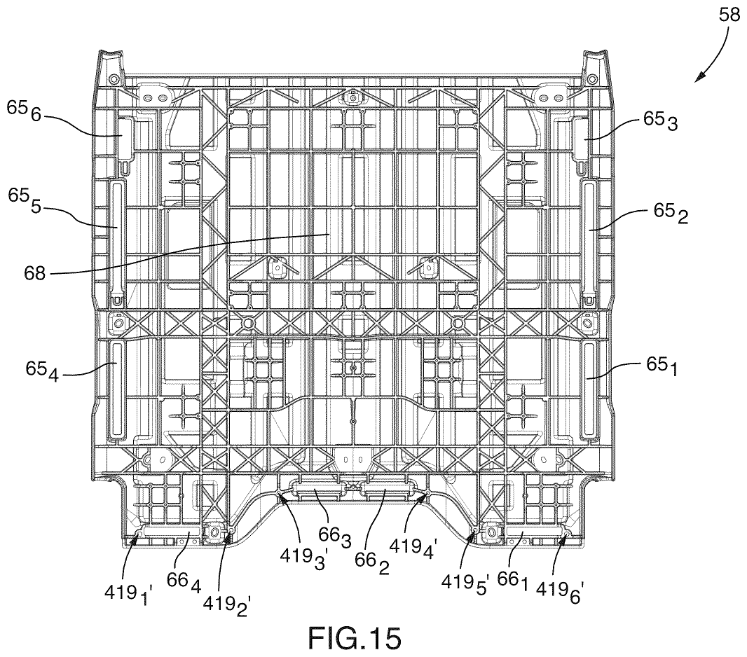

With further reference to FIGS. 10 to 15, the cargo bed 58 comprises an upper surface 60, side portions 61₁ and 61₂ (also referred to as lateral portions 61₁, 61₂ which generally extend along respective lateral edges of the cargo bed 58—the lateral portion 61₁ is a left side/lateral portion of the cargo bed 58 and the lateral portion 61₂ is a right side/lateral portion of the cargo bed 58), a front portion 64 (which generally extends along a front edge of the cargo bed 58) and a rear portion 62 (which generally extends along a rear edge of the cargo bed 58).

The upper surface 60 of the cargo bed 58 comprises a plurality of lateral apertures generally positioned longitudinally along the lateral portions 61₁ and 61₂. In this embodiment, the upper surface 60 comprises 3 lateral apertures 65₁, 65₂ and 65₃ positioned longitudinally along the lateral side portion 611 (specifically, along a left lateral edge of the upper surface 60) and 3 lateral apertures 65₄, 65₅ and 65₆ positioned longitudinally along the lateral side portion 61₂ (specifically, along a right lateral edge of the upper surface 60). The lateral apertures 65₁₋₆ each have a generally elongated shape along the longitudinal direction of the cargo bed 58.

Still in this embodiment, within each one of the lateral side portions 61₁ and 61₂, respective ones of the lateral apertures 65₁₋₆ are longitudinally spaced from one another and at least one of respective ones of the lateral apertures 65₁₋₆ is laterally spaced relative to the other lateral apertures (i.e., at least one of respective one of the lateral apertures 65₁₋₆ is not longitudinally aligned with remaining ones of the lateral apertures 65₁₋₆ along respective ones of the lateral portions 61₁ and 61₂).

Specifically, within the lateral side portion 61₁, the lateral aperture 65₃ is laterally spaced relative to the lateral apertures 65₁ and 65₂ (i.e., the lateral aperture 65₃ is not longitudinally aligned with the lateral apertures 65₁ and 65₂ and is closer from a center region of the upper surface 60 of the cargo bed 58). Similarly, within the lateral side portion 61₂, the lateral aperture 65₆ is laterally spaced relative to the lateral apertures 65₄ and 65₅ (i.e., the lateral aperture 65₆ is not longitudinally aligned with the lateral apertures 65₄ and 65₅ and the lateral aperture 65₆ is closer from a center region of the upper surface 60 of the cargo bed 58). In other words, at least one of the lateral apertures 65₁₋₆ is spaced in a widthwise direction of the cargo box 50 from remaining ones of the lateral apertures 65₁₋₆ along respective ones of the lateral portions 61₁ and 61₂. On each one of the lateral portions 61₁ and 61₂, relevant ones of the lateral apertures 65₁₋₆ are also spaced in a longitudinal direction of the cargo box 50. This configuration of the lateral apertures 65₁₋₆ generally confers an increased stability (i.e., longitudinal and/or lateral stability) to respective one of the side walls 54₁, 54₂ when the side walls 54₁, 54₂ are removably engaged with the cargo bed 58.

The lateral apertures 65₁₋₆ generally extend from the upper surface 60 towards a bottom surface 68 of the cargo bed 58 (i.e., the lateral apertures 65₁₋₆ define corresponding holes or passages in the cargo bed 58) and the cargo bed 58 defines a plurality of open areas under each one of the lateral apertures 65₁₋₆ (i.e., under respective holes or passages thereby providing access to respective open areas). The presence of these open areas under respective ones of the lateral apertures 65₁₋₆ ensures unimpeded ingress of elements of the side walls 54₁, 54₂ within the lateral apertures 65₁₋₆.

It will be readily appreciated that any other suitable configuration of the lateral apertures 65₁₋₆ (in terms of the number of lateral apertures along the lateral portions 61₁ and 61₂, as well as the position and/or dimensions of the lateral apertures along the longitudinal and/or lateral directions of the cargo bed 58) may be possible in other non-limiting embodiments. In addition, in further non-limiting embodiments the lateral apertures 65₁₋₆ may be substituted for lateral recesses (in which case the lateral recesses do not fully extend from the upper surface 60 towards the bottom surface 68 of the cargo bed 58 and accordingly do not define corresponding holes or passages providing an access to corresponding open areas under the cargo bed 58).

The upper surface 60 of the cargo bed 58 also comprises a plurality of front apertures 66₁₋₄ generally positioned along the front portion 64 of the cargo bed 58. In this embodiment, the upper surface 60 comprises 4 front apertures 66₁, 66₂, 66₃ and 66₄ positioned along the front portion 64 (specifically, along a front edge of the upper surface 60). The front apertures 66₁₋₄ each have a generally elongated shape along the lateral direction of the cargo bed 58.

Still in this embodiment, the front apertures 66₁₋₄ are laterally spaced from one another and at least one of the front apertures 66₁₋₄ is longitudinally spaced relative to the other front apertures 66₁₋₄ (i.e., at least one of the front apertures 66₁₋₄ is not laterally aligned with remaining ones of the front apertures 66₁₋₄). Specifically, and as a result of the geometrical configuration of the front wall 52 (which comprises a generally recessed region designed to provide space for the user of the off-road vehicle 10 when the user sits on the seat 24), in this embodiment the front apertures 66₂ and 66₃ are longitudinally spaced relative to the front apertures 66₁ and 66₄ (i.e., the front apertures 66₂ and 66₃ are not laterally aligned with the front apertures 66₁ and 66₄ and are closer from a center region of the upper surface 60 of the cargo bed 58). It will be readily appreciated that the configuration of the front wall 52 (including the configuration of the front apertures 66₁₋₄) contributes to the longitudinal and/or vertical stability of the front wall 52, while at the same time increasing a volume of the cargo box 50 and accommodating a user of the vehicle 10 when the user rests on the seat 24.

The front apertures 66₁₋₄ generally extend from the upper surface 60 towards the bottom surface 68 of the cargo bed 58 (i.e., the front apertures 66₁₋₄ define corresponding holes or passages in the cargo bed 58) and the cargo bed 58 defines a plurality of open areas under each one of the front apertures 66₁₋₄ (i.e., under respective holes or passages providing access to respective open areas from the upper surface 60 of the cargo bed 58). The presence of these open areas under respective ones of the front apertures 66₁₋₄ ensures unimpeded ingress of elements from the front wall 52 within the front apertures 66₁₋₄.

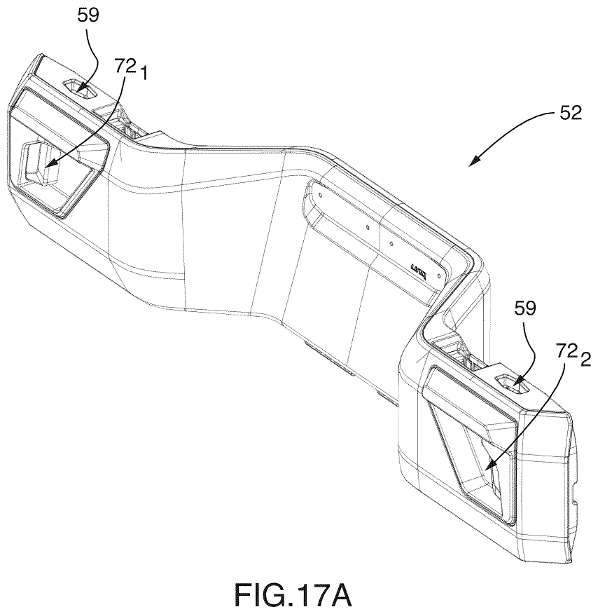

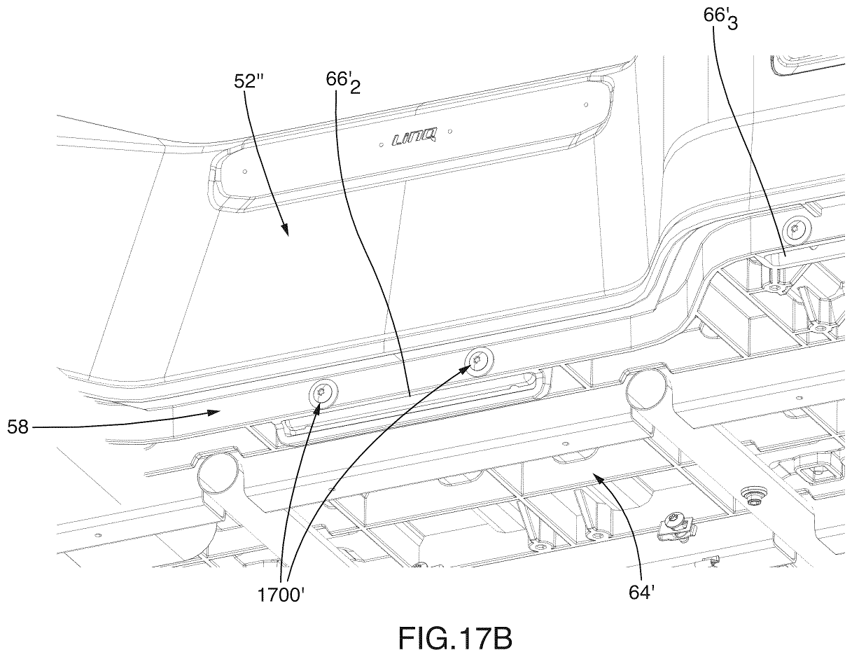

It will be readily appreciated that any other suitable configuration of the front apertures 66₁₋₄ (in terms of the number of front apertures along the front portion 64 of the cargo bed 58, as well as the position of the front apertures 66₁₋₄ along the longitudinal and/or lateral directions of the cargo bed 58) may be possible in other embodiments. For example, with further reference to FIG. 17B, a front portion 64′ comprising three front apertures 66′₁₋₃ is shown. In addition, in further non-limiting embodiments the front apertures may be substituted for front recesses (in which case the front recesses do not fully extend from the upper surface 60 towards the bottom surface 68 of the cargo bed 58 and accordingly do not define corresponding holes or passages providing an access to corresponding open areas under the cargo bed 58).

In further non-limiting embodiments, the front apertures 66₁₋₄ may also be substituted for front recesses (in which case the front recesses do not fully extend from the upper surface 60 towards the bottom surface 68 of the cargo bed 58 and accordingly do not define corresponding holes or passages providing an access to corresponding open areas under the cargo bed 58).

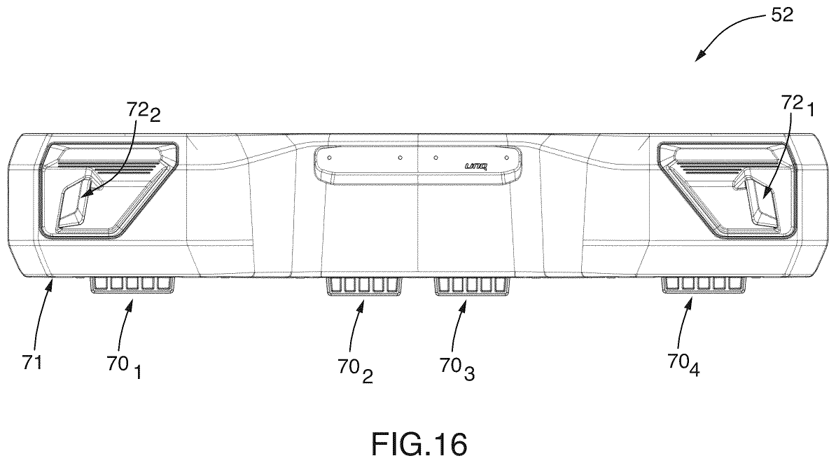

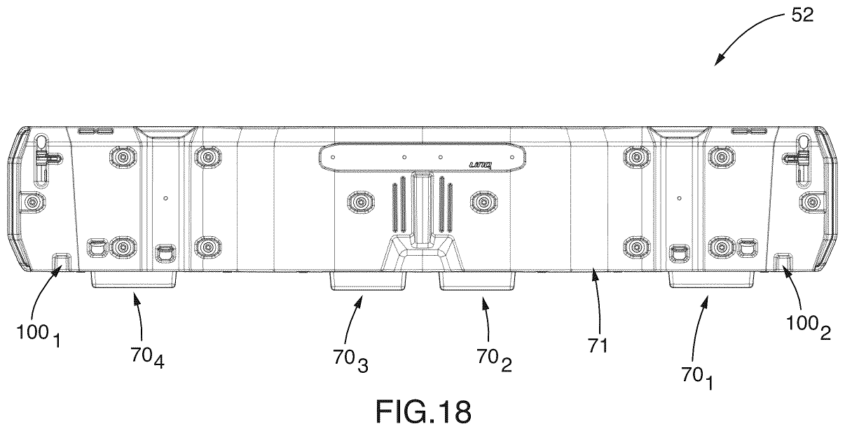

With further reference to FIGS. 16 to 18, the front wall 52 of the cargo box 50 is configured for removable engagement with the cargo bed 58 (specifically, with the upper surface 60 of the cargo bed 58), the front wall 52 comprising a lower surface 71 configured to engage the upper surface 60 of the cargo bed 58. To this end, the front wall 52 comprises a plurality of cleats 70₁₋₄ configured to removably occupy the front apertures 66₁₋₄ of the cargo bed 58. In other words, when the front wall 52 and the cargo bed 58 are fully engaged, each one of the plurality of cleats 70₁₋₄ occupies corresponding ones of the front apertures 66₁₋₄ (specifically, the cleat 70₁ occupies corresponding front aperture 66₁, the cleat 70₂ occupies corresponding front aperture 66₂, the cleat 703 occupies corresponding front aperture 66₃ and the cleat 70₄ occupies corresponding front aperture 66₄), at least a portion of each one of the plurality of cleats 70₁₋₄ protruding away from the bottom surface 68 of the cargo bed 58 when the lower surface 71 of the front wall 52 engages the upper surface 60 of the cargo bed 58.

In this embodiment, the open areas defined under each one of the front apertures 66₁₋₄ do not impede ingress of each one of the plurality of cleats 70₁₋₄ within corresponding ones of the front apertures 66₁₋₄. While the number of front apertures (or recesses) of the cargo bed 58 and cleats of the front wall 52 are the same in this embodiment, the number of front apertures (or recesses) of the cargo bed 58 and cleats of the front wall 52 may be different in other non-limiting embodiments (as long as there are no more cleats that apertures (or recesses)). In addition, while four cleats 70₁₋₄ are shown in this embodiment it will be appreciated that any other suitable number of cleats (and corresponding front apertures or recesses of the cargo bed 58) could be used in other non-limiting embodiments. For example, another non-limiting embodiment of the front wall 52″ and the cargo bed is shown in FIG. 17B, and in which the front wall 52″ comprises three cleats 70″₁₋₃ (not shown) configured for engagement with three front apertures 66′₁₋₃ of the cargo bed.

Still in this embodiment, the front wall 52 further comprises latch assembly elements 72₁ and 72₂, present on a front side of the front wall 52 and within lateral side portions of the front wall 52. As further described below, in combination with hook elements 96₁₋₂ present on the side walls 54₁₋₂, the latch assembly elements 72₁₋₂ and corresponding hook elements 96₁₋₂ form latch assemblies 73₁₋₂ (not shown-the latch assembly 73₁ being a left latch assembly comprising the latch assembly element 72₁ and the hook element 96₁, and the latch assembly 73₂ being a right latch assembly comprising the latch assembly element 72₂ and the hook element 96₂). Each one of the latch assembly elements 72₁ and 72₂ present in the front wall 52 is accordingly configured to reversibly engage (i.e., to engage and disengage) the corresponding hook element 96₁₋₂ present in respective ones of the side walls 54₁₋₂.

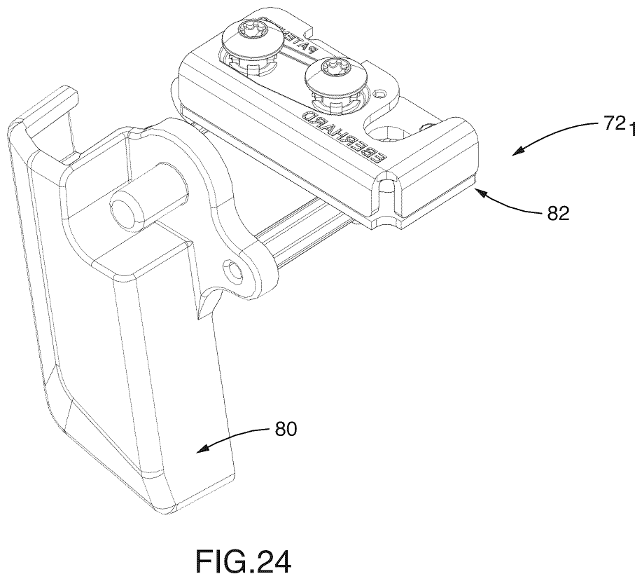

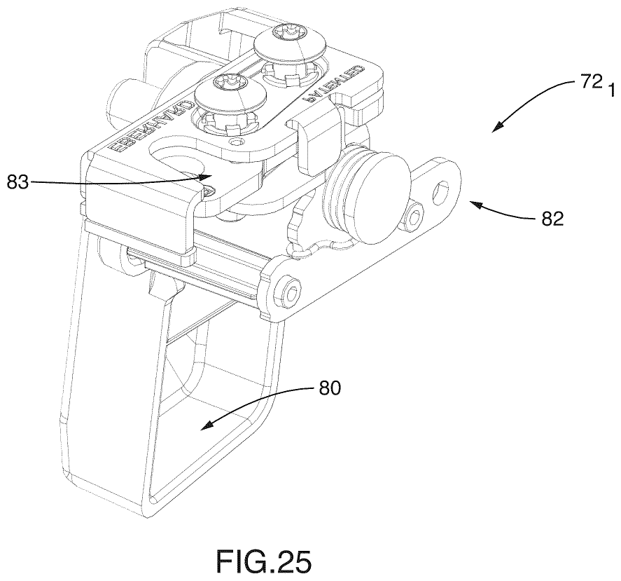

With further reference to FIGS. 24 to 26, the latch assembly element 72₁ (i.e., the left latch assembly), which comprises a handle 80 operatively connected to a latch 82, is shown. The handle 80 is generally configured for ergonomic engagement by a user to activate a mechanism of the latch 82. In this embodiment, the latch 82 comprises a mechanism allowing it to move between an engaged (or locked) position and a disengaged (or unlocked) position, the corresponding hook element 96₁ being receivable within a recess 84 of the latch 82.

It will be readily appreciated that the movement of the latch 82 may be achieved either by positioning the hook element 96₁ within the recess 84 (in which case a user exerts a force onto the flange 83 via the hook element 96₁, which results in the movement of the flange 83 thereby unlocking the latch 82), or by a user engaging the handle 80 which also results in the movement of the flange 83 thereby providing access to the recess 84 and unlocking the latch 82. In this embodiment, the flange 83 is configured to rotate relative to the latch 82, however any other suitable mechanism/motion (e.g., sliding motion), or any other suitable latch/latch mechanism, could be used in other non-limiting embodiments. The handle 80 is operatively connected to the latch 82 such that when the user engages the handle 80 the flange 83 is moved to enable the removal of the hook element 96₁ from within the recess 84. In other words, in the engaged position, the flange 83 also prevents disengagement of the hook element 96₁ from within the recess 84 (up and until the user engages the handle 80). The engagement between the latch 82 and the hook element 96₁ ensures that the front wall 52 and the side walls 54₁₋₂ remain securely fastened until manual disengagement is initiated by the user through the handle 80. It will be readily appreciated that the latch assembly element 72₂ is similarly configured and that any suitable latch assembly and/or latch assembly mechanism may be used in other non-limiting embodiments.

As a result of the presence of the first connection mechanism with a plurality of elements present on the side walls 54₁, 54₂, the cargo bed 58 and the front wall 52 (specifically the plurality of cleats 70/corresponding ones of the front apertures 66 and the latch assemblies 73 12 present on the front wall 52, the side walls 54₁₋₂ and the cargo bed 58), the front wall 52 is generally configured for toolless engagement and disengagement with the cargo bed 58 and the side walls 54₁₋₂ in this non-limiting embodiment (i.e., without necessitating the use of any tools or implements).

In further non-limiting embodiments, the front wall 52 of the cargo box 50 may also be fastened (or further fastened, if for example the front wall is secured to the side walls 54₁₋₂ via the latch assemblies 73₁₋₂ or engaged with the cargo bed 58 via the plurality of cleats 70 / corresponding ones of the front apertures 66) to the cargo bed 58 via a second connection mechanism. As further described below, the second connection mechanism comprises a plurality of tools and a plurality of corresponding fastening apertures that may be present on both the front wall 52 and the cargo bed 58.

The second connection mechanism notably enables the front wall 52 to be engageable with the cargo bed 58 using a plurality of tools or implements. In this embodiment, the front wall 52 is engageable with the cargo bed 58 when the side walls 54₁₋₂ and the tailgate 56 are engaged with the cargo bed 58, or when the side walls 54₁₋₂ and the tailgate 56 are not engaged with (i.e., have been removed from) the cargo bed 58. The front wall 52 is accordingly removeable form the cargo bed 58 to obtain a flat platform configuration when the side walls 54₁₋₂ and the tailgate 56 are removed from the cargo bed 58.

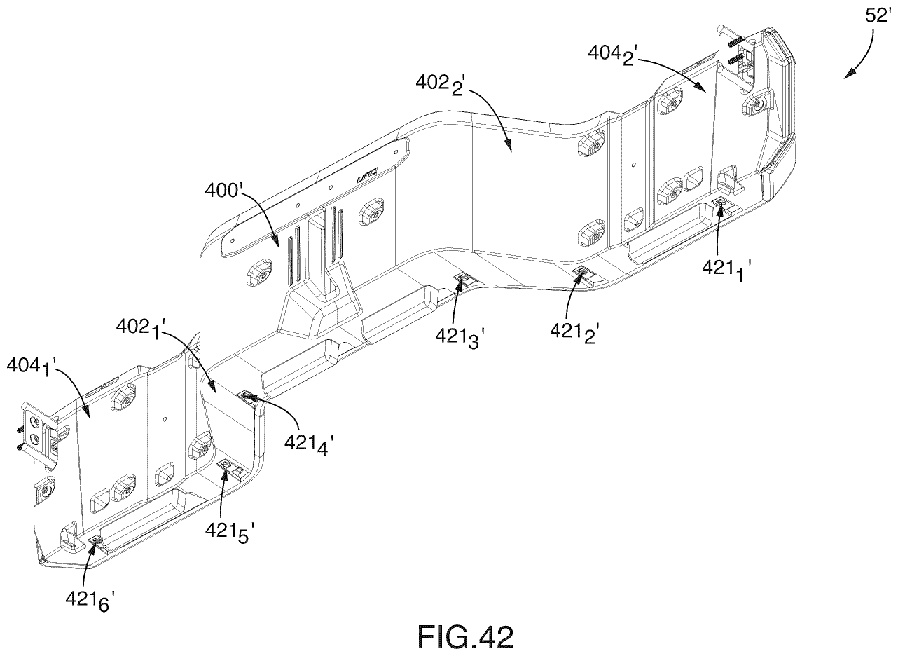

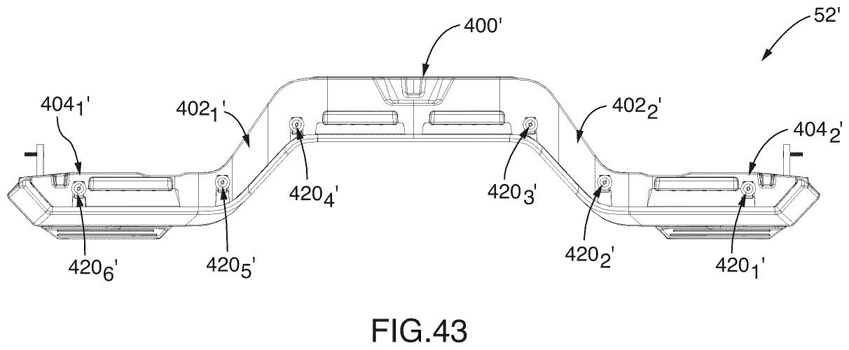

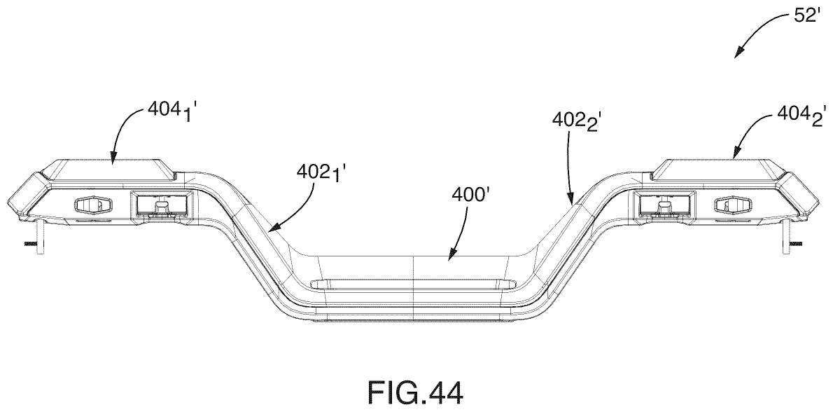

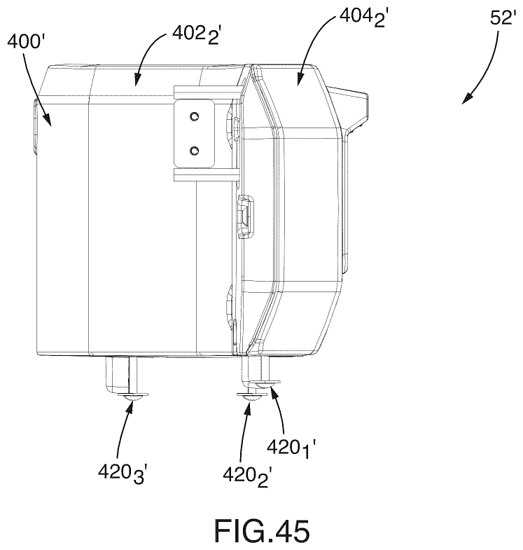

A non-limiting embodiment of the front wall 52′ of the cargo box 50 configured to be engageable with the cargo bed 58 using a plurality of tools or implements is shown in FIGS. 42 to 49. The front wall 52′ of the cargo box 50 comprises a central portion 400′, two intermediate portions 402₁′, 402₂′ (the intermediate portion 402₁′ being a left intermediate portion and the intermediate portion 402₂′ being a right intermediate portion) and two lateral portions 404₁′, 404₂′ (the lateral portion 404₁′ being a left lateral portion and the lateral portions 404₂′ being a right lateral portion), the two intermediate portions 402₁′, 402₂′ generally connecting respective ones of the two lateral portions 404₁′, 404₂′ to the central portion 400′. Still in this embodiment, the central portion 400′ is spaced longitudinally from the lateral portions 404₁′, 404₂′ such that the central portion 400′ generally projects rearward from a plane defined by and coextensive with the lateral portions 404₁′, 404₂′. The intermediate portions 402₁′, 402₂′ generally extend diagonally and transversally between the central portion 400′ and the lateral portions 404₁′, 404₂′ relative to the longitudinal and lateral directions of the cargo box 50. It will be readily appreciated that this configuration provides space for the straddle seat 24 while also providing additional storage room on the lateral portions 61₁₋₂ of the cargo bed 58.

The front wall 52′ also comprises a plurality of cleats 70′ extending from the lower surface 71′ of the front wall 52′. In this embodiment, the front wall 52′ comprises one cleat in each one of the lateral portions 404₁′, 404₂′ and two cleats in the central portion 400′ (i.e., the lateral portion 404₂′ comprises a cleat 70₁′, the lateral portion 404₂′ comprises a cleat 70₄′ and the central portion 400′ comprises two cleats 70₂′ and 70₃′). It will be appreciated that any other suitable number and/or configuration of the cleats (e.g., in terms of the number of cleats per central portion 400′/lateral portion 404₁′/404₂′) may be possible in other non-limiting embodiments.

The cleats 70₁₋₄′ being present on the central portion 400′ and the lateral portions 404₁′, 404₂′, the cleats 70₁₋₄′ are also spaced in a longitudinal direction of the front wall 52′. Specifically, in this embodiment, the two cleats 70₂′ and 70₃′ of the central portion 400′ are longitudinally spaced apart from the cleats 70₁′ and 70₄′ of the lateral portions 404₁′ and 404₂′. This configuration of the cleats 70₁₋₄′ generally confers an increased stability (i.e., a vertical and/or lateral and/or longitudinal stability) of the front wall 52′ relative to the cargo bed 58 when the cargo bed 58 and the front wall 52′ are removably engaged (via engagement between the plurality of cleats 70′ and the plurality of front apertures 66 of the cargo bed 58).

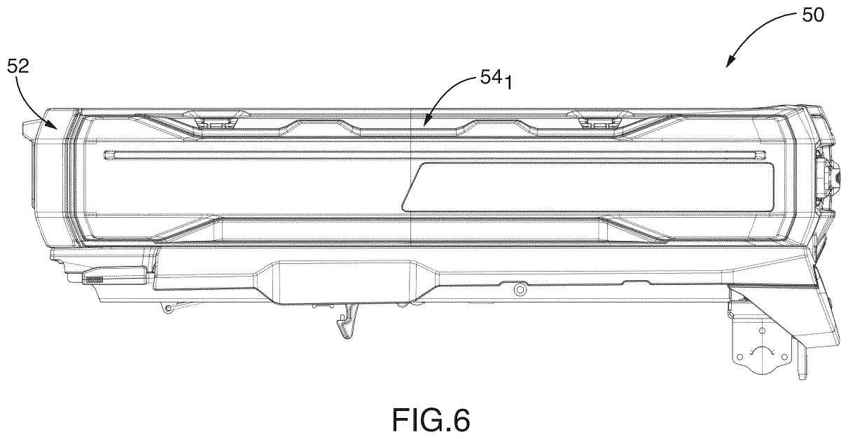

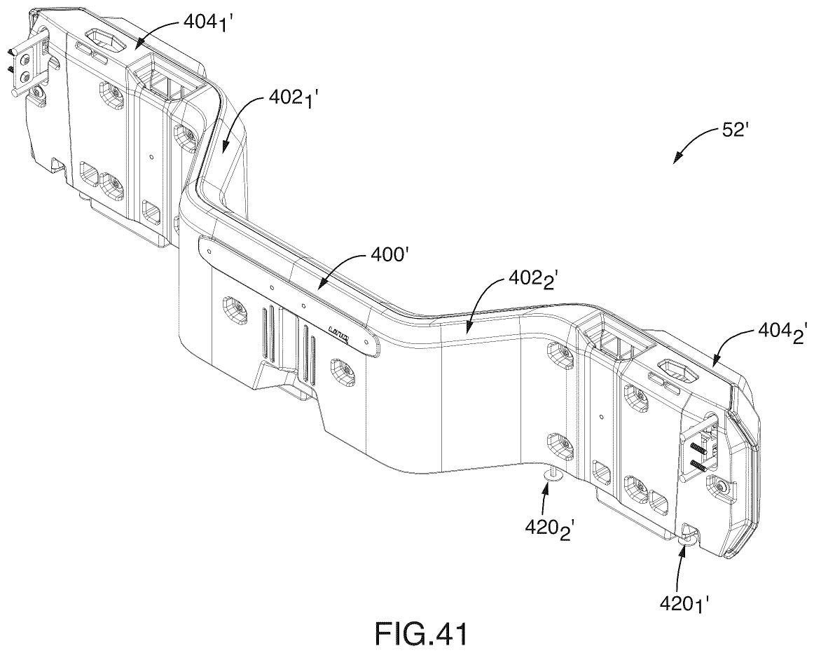

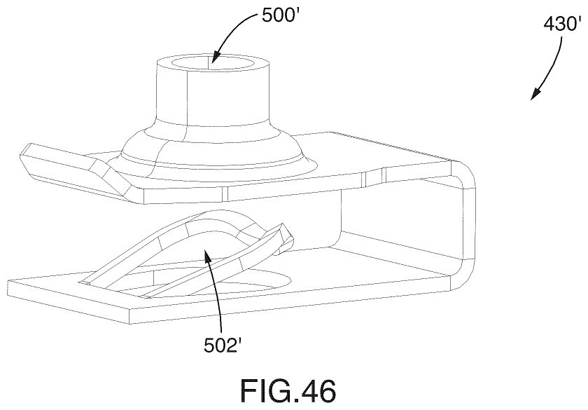

Still in this embodiment, the front wall 52′ may be removably secured to the cargo bed 58 via a plurality of removable fasteners 420′. In the non-limiting embodiment shown in FIGS. 42 to 49, 6 removable fasteners 420₁₋₆′ may be used to secure the front wall 52′ to the cargo bed 58, the removable fasteners 420₁₋₆′ being generally configured to extend vertically through corresponding apertures 419₁₋₆′ of the cargo bed 58 (as shown in FIG. 41), and into corresponding apertures (or recesses) 421₁₋₆′ present in a bottom portion of the front wall 52′. With specific reference to FIG. 46, each one of the removable fasteners 420₁₋₆′ is configured to engage each one of the corresponding apertures 421₁₋₆′ present in the bottom portion of the front wall 52′. In this embodiment, the front wall 52′ comprises two apertures 421₃′ and 421₄′ in the central portion 400′ of the front wall 52′, two apertures 421₁′ and 421₂′ in the lateral portion 404₂′ of the front wall 52′ and two apertures 421₅′ and 421₆′ in the lateral portion 404₁′ of the front wall 52′. The two apertures 421₃′ and 421₄′ of the central portion 400′ are longitudinally spaced apart from the apertures 421₅′ and 421₆′/421₁′ and 421₂′ of the lateral portions 404₁′/404₂′, respectively.

The cargo bed 58 similarly comprises two apertures 419₃′ and 419₄′ in a central portion of the front wall 52′, two apertures 421₁′ and 421₂′ in the lateral portion 404₂′ of the front wall 52′ and two apertures 421₅′ and 421₆′ in the lateral portion 404₁′ of the front wall 52′. The two apertures 421₃′ and 421₄′ of the central portion 400′ are longitudinally spaced apart from the apertures 421₅′ and 421₆′/421₁′ and 421₂′ of the lateral portions 404₁′/404₂′, respectively.

This configuration of the apertures (or recesses) 421₁₋₆′, as well as the removable fasteners 420₁₋₆′ when engaged into the apertures 421₁₋₆′, generally confers an increased stability (i.e., a vertical and/or lateral and/or longitudinal stability) of the front wall 52′ relative to the cargo bed 58 when the cargo bed 58 and the front wall 52′ are removably engaged via the 6 removable fasteners 420₁₋₆′. It will be readily appreciated that any other suitable number and/or configuration of the removable fasteners 420′ may be used in other non-limiting embodiments (e.g., in terms of the number of removable fasteners per central portion 400′/lateral portion 404₁′/404₂′). In some non-limiting examples, the front wall 52′ may comprise at least 4 removable fasteners 420′, but no more than 8 removable fasteners 420′. In further non-limiting examples, at least one of the central portion 400′/lateral portion 404₁′/404₂′ of the front wall 52′ may comprise a number of removable fasteners 420′ that is different from the number of removable fasteners 420′ in remaining ones of the central portion 400′/lateral portion 404₁′/404₂′.

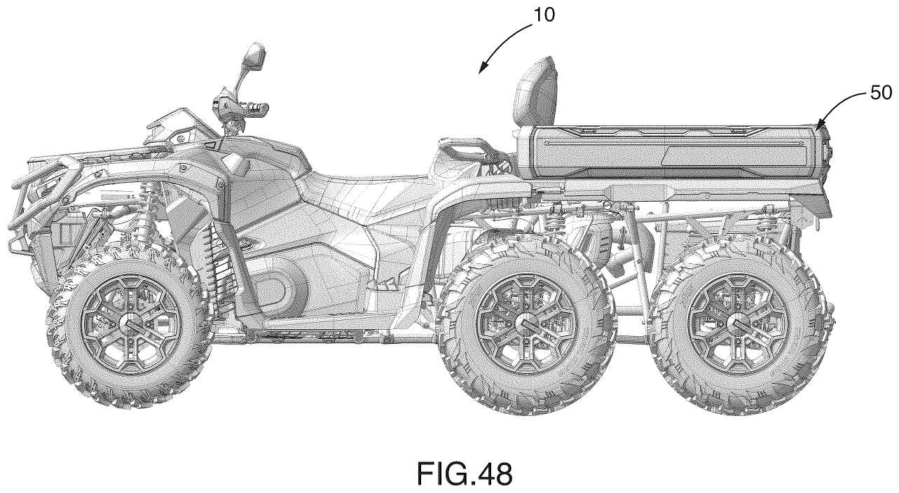

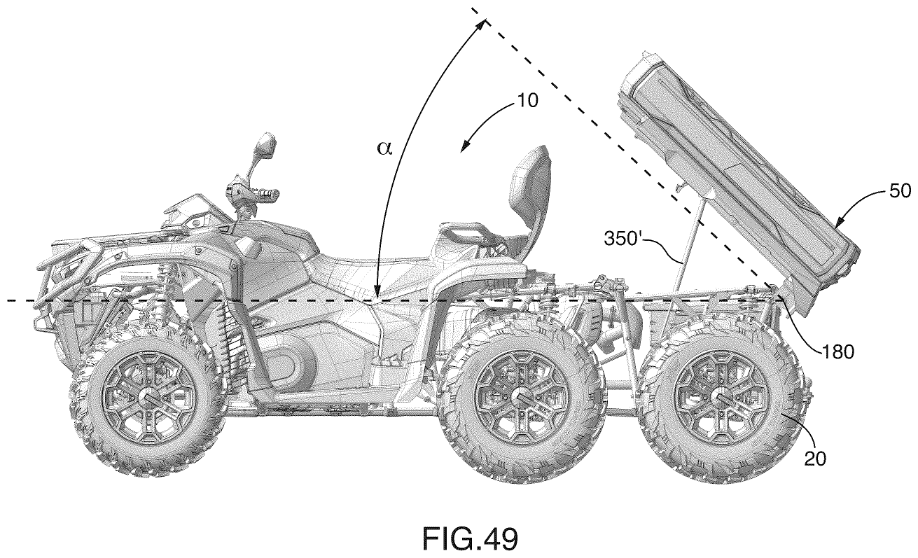

It will be readily appreciated that the removable fasteners 420′ are readily accessible to a user of the off-road vehicle 10 for engagement and disengagement, for example via the bottom portion of the front wall 52′ through which the removable fasteners 420′ can be vertically inserted in the corresponding apertures (or recesses) 421′ present in the bottom portion of the front wall 52′. In addition, when the front wall 52′ is engaged onto the cargo bed 58 via interlocking engagement between the front apertures 66₁₋₄ of the cargo bed 58 and the corresponding cleats 70₁₋₄′ of the front wall 52′, the apertures 421′ present in the bottom portion of the front wall 52′ are generally aligned longitudinally and laterally with the corresponding apertures 419′ of the cargo bed 58, such that the removable fasteners 420′ can be inserted at the same time in the corresponding apertures 419′ of the cargo bed 58 and the corresponding apertures (or recesses) 421′ present in the bottom portion of the front wall 52′—this is referred to as the inserted position of the removable fasteners 420′. Once in the inserted position, the removable fasteners 420′ generally protrude away from the bottom portion of the front wall 52′/the cargo bed 58 such that they are readily accessible to the user of the off-road vehicle 10 for disengagement or removal. With further reference to FIGS. 48 and 49, the removable fasteners 420′ may be accessible to the user of the off-road vehicle 10 when the cargo box 50 is in a generally operational (or horizontal) configuration (relative to the off-road vehicle 10), but may also be accessible to the user of the off-road vehicle 10 only after the cargo box 50 has been moved from the horizontal configuration into a release (or raised) configuration.

In this embodiment, the cargo box 50 is pivotably mounted relative to the frame 12 of the off-road vehicle 10 (i.e., relative to a rear portion of the frame 12). In other words, the cargo box 50 is selectively moveable between various positions, and which can be characterized by an angle between a base of the cargo box 50 and a horizontal plane of the off-road vehicle 10 coextensive with a pivot axis of the cargo box 50, as further described below (this angle is 0° in FIG. 48 and a in FIG. 49). The cargo box 50 is pivotably moveable relative frame 12 via shafts (not shown) which define a pivot axis 180 between the cargo box 50 and the frame 12, the pivot axis 180 extending generally laterally at a rear end of the cargo box 50/frame 12 of the off-road vehicle 10, specifically rearward an axis of rotation of the rear wheels 20.

In the configuration of FIG. 48, the cargo box 50 is in a horizontal (or operational) configuration, which can be used when the off-road vehicle 10 is in motion. In FIG. 49, the cargo box 50 is in an angled (or release) configuration, which can be used when the off-road vehicle 10 is still to assist a user of the off-road vehicle 10 in emptying the cargo box 50. To facilitate pivoting the cargo box 50 around the pivot axis 180, the off-road vehicle 10 may optionally further comprise a cylinder 350′ between the cargo box 50 and the frame 12, forward to the pivot axis 180 along a longitudinal direction of the off-road vehicle 10. In some non-limiting embodiments, the cylinder 350′ may be spring loaded to facilitate lifting and/or closing the cargo box 50 (i.e., moving the cargo box 50 from the horizontal (or operational) configuration to the angled (or release) configuration, and vice versa).

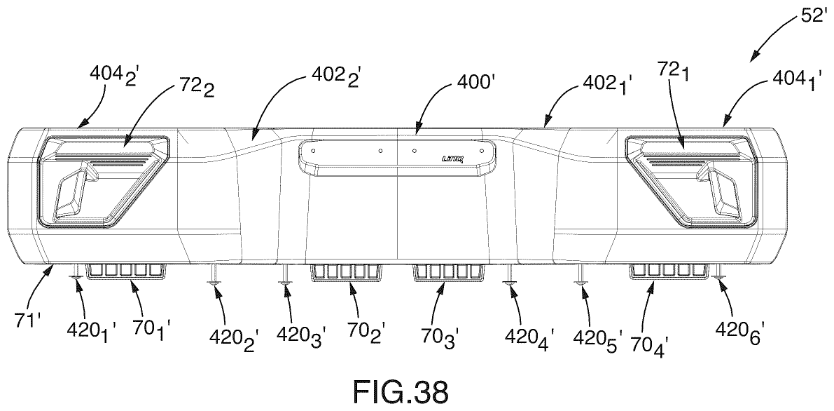

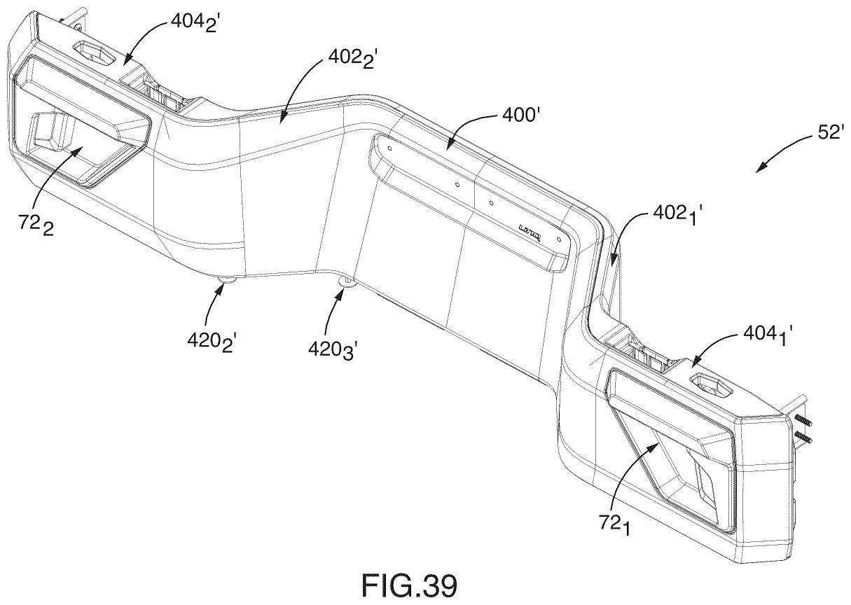

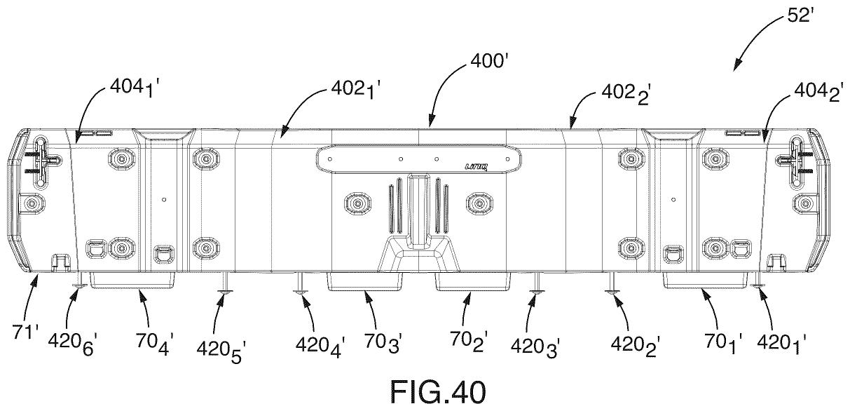

In the non-limiting embodiment of FIGS. 38 to 45, the removable fasteners 420′ are bolts configured to extend vertically through the corresponding apertures 419₁₋₆′ the cargo bed 58 and through the corresponding apertures (or recesses) 421₁₋₆′ present in the bottom portion of the front wall 52′. FIG. 46 shows a non-limiting embodiment of a bolt connector 430′ that is configured for insertion in the bottom portion of the front wall 52′. The bolt connector 430′ comprises two generally circular apertures 500′, 502′, which are configured to be generally aligned vertically with the corresponding apertures (or recesses) 421′ present in the bottom portion of the front wall 52′, to secure the bolts in the inserted position. In further non-limiting embodiments, the removeable fasteners 420′ may be spring-loaded ball lock pins (not shown), in which case the corresponding apertures 421′ present in the bottom portion of the front wall 52′ are locking recesses (not shown). Any other suitable removable fastener may be used in further non-limiting embodiments.

Another embodiment of the front wall 52″ of the cargo box 50 configured to be engageable with the cargo bed 58 using a plurality of tools or implements is shown in FIG. 17B. The front wall 52″ may be removably secured to the cargo bed 58 via a plurality of removable fasteners 1700′, the fasteners 1700′ generally extending longitudinally (i.e., along a horizontal plane of the cargo bed 58/cargo box 50) through a plurality of corresponding (longitudinal) apertures present on both the front wall 52″ and the cargo bed 58. In this embodiment, the fasteners 1700′ are screws, however any other suitable means to securely connect the fastening apertures present on both the front wall 52″ and the cargo bed 58 may be used, such as but not limited to bolts and the likes.

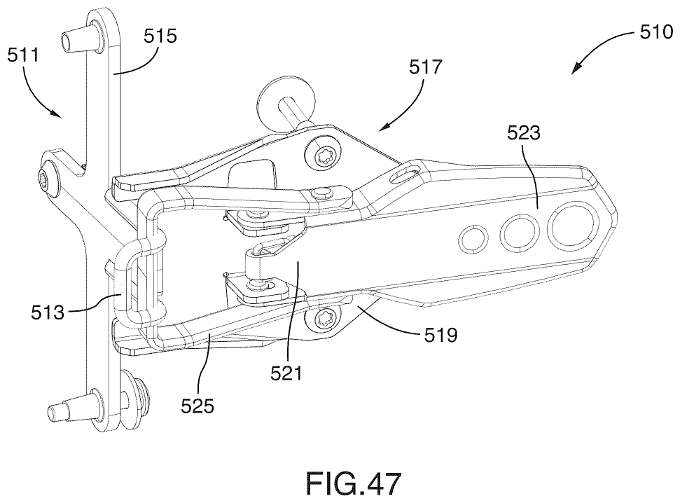

In further non-limiting embodiments, and with further reference to FIG. 47, the front wall 52/52′/52″ may further comprise latches 510 on lateral side portions thereof, the latches 510 being configured for attaching the front wall 52/52′/52″ to the cargo bed 58. In some embodiments, the latch has two elements: (i) an anchor part 511 having a hook portion 513 and a first plate portion 515; and (ii) a locking part 517, the locking part 517 comprising a second plate portion 519, a lever 521 (which may be spring-loaded in some non-limiting examples) pivotally connected to the second plate portion 519 and comprising a handle 523 and a loop 525 connected to the lever 521 such that moving the lever 521 (e.g., using the handle 523) moves the loop 525. The loop 525 is configured to selectively engage the hook portion 513 of the anchor part 511.

In yet further non-limiting embodiments, the front wall 52/52′/52″ may comprise the locking part 517 at a bottom end portion thereof (in which case the lever 521 may be oriented vertically) and a front portion of the cargo bed 58 may comprise the anchor part 511, while in yet further non-limiting embodiments the front wall may 52 may comprise the anchor part 511 and the front portion of the cargo bed 58 may comprise the locking part 517.

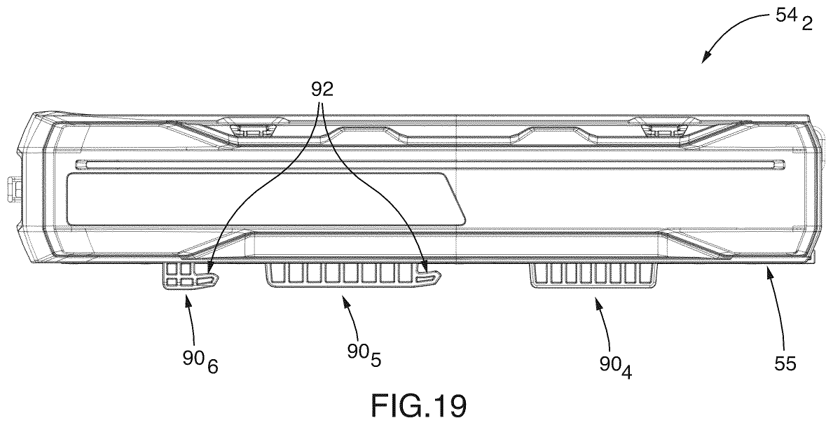

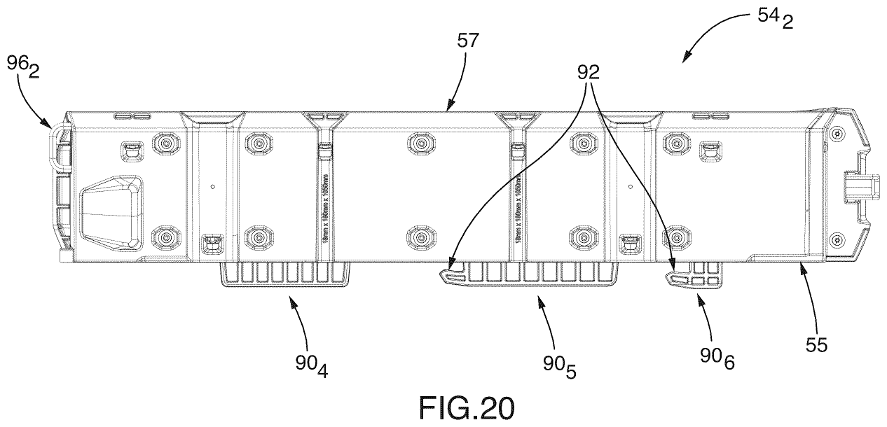

With further reference to FIGS. 19 to 21, the side wall 54₂ comprises a plurality of cleats 90₄₋₆ on a bottom surface 55 of the side wall 54₂, each one of the plurality of cleats 90₄₋₆ being configured to removably engage corresponding ones of the lateral apertures 65₁₋₆ of the cargo bed 58. In this embodiment, the cleat 90₄ is configured to engage the lateral aperture 65₄, the cleat 90₅ is configured to engage the lateral aperture 65₅ and the cleat 90₆ is configured to engage the lateral aperture 65₆. While the number of lateral apertures (or recesses) of the cargo bed 58 and cleats of the side wall 54₂ are the same in this embodiment, the number of front apertures (or recesses) of the cargo bed 58 and cleats of the side wall 54₂ may be different in other non-limiting embodiments (as long as there are no more cleats that apertures (or recesses)).

Of note, in this embodiment each one of the cleats 90₁₋₆ has a length at a bottom portion thereof and along the longitudinal direction of the side walls 54₁₋₂ that is not greater than a length of the corresponding lateral aperture 65₁₋₆ along the longitudinal direction of the cargo bed 58. Still in this embodiment, and as further described below, the length at the bottom of the cleats 90₁₋₆ may be greater than a length at the intermediate or top portion thereof.

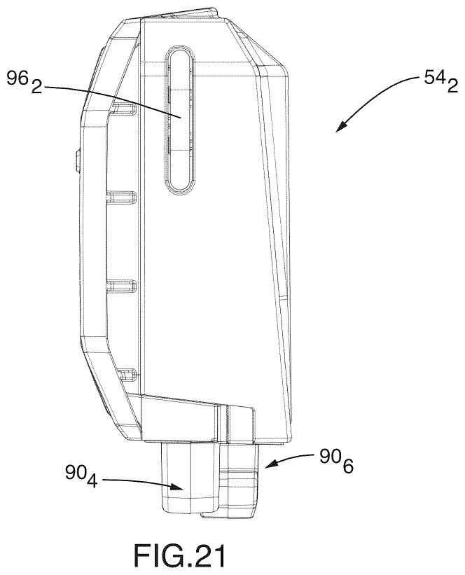

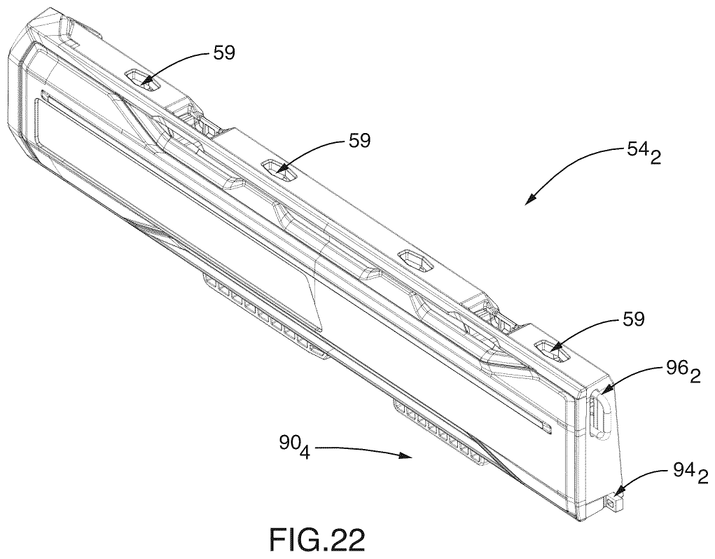

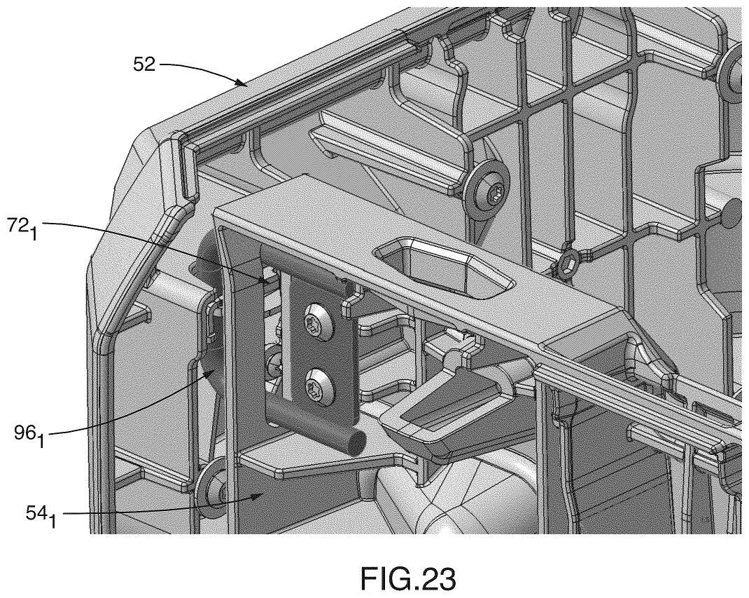

As such, much like the lateral apertures 65₄₋₆ of the cargo bed 58, the cleats 90₄₋₆ are longitudinally spaced from one another along a longitudinal direction of the side wall 54₂ and at least one of the cleats 90₄₋₆ is laterally spaced relative to the other cleats (i.e., at least one of the cleats 90₄₋₆ is not longitudinally aligned with remaining ones of the of the cleats 90₄₋₆ on the side wall 54₂). Specifically, within the side wall 54₂, the cleat 90₆ is laterally spaced relative to the cleats 90₄ and 90₅ (as better shown in FIG. 21—i.e., the cleat 90₆ is not longitudinally aligned with the cleats 90₄ and 90₅). In other words, at least one of the cleats 90₁₋₆ is spaced in a widthwise direction from remaining ones of the cleats 90₁₋₆ on respective one of the side walls 54₁₋₂. On each one of the side walls 54₁₋₂, relevant ones of the cleats 90₁₋₆ are also spaced in a longitudinal direction of the side walls 54₁₋₂. This configuration of the cleats 90₁₋₆ generally confers an increased stability (i.e., a vertical and/or lateral stability) of the side walls 54₁₋₂ relative to the cargo bed 58 when the cargo bed 58 and the side walls 54₁₋₂ are removably engaged.

It will be readily appreciated that the side wall 54₁ is similarly configured and therefore also comprises a plurality of cleats 90₁₋₃ (not shown) with a configuration similar to the configuration of the cleats 90₄₋₆ of the side wall 54₂ as described above and that, as a result of this configuration and the engagement of the cleats 90₁₋₃ and the lateral apertures 65₁₋₃ of the cargo bed 58, an increased stability (i.e., a vertical and/or lateral stability) is also conferred to the side wall 54₂ relative to the cargo bed 58 when the cargo bed 58 and the side wall 54₂ are removably engaged.

In this embodiment, at least some of the cleats 90₄₋₆ of the side wall 54₂ comprise a notch 92 generally extending along a longitudinal direction of the side wall 54₂ and configured to occupy the open space on the underside of the cargo bed 58 to lockingly engage the side wall 54₂ with the cargo bed 58. Specifically, when the side wall 54₂ and the cargo bed 58 are engaged the notch 92 prevents or generally impedes an upward motion of the side wall 54₂ relative to the cargo bed 58. In addition, it will be readily appreciated that, in this embodiment, the upward motion of the side wall 54₂ relative to the cargo bed 58 is further prevented by the engaged of the side wall 54₂ and the front wall 52 via the latch assembly 73₂. Again, the side wall 54₁ may be similarly configured.

On its front side, and with reference to FIG. 21, the side wall 54₂ further comprises a hook element 96₂, the hook element 96₂ of the side wall 54₂ and the corresponding latch assembly element 72₂ of the front wall 52 forming together the latch assembly 73₂. In this embodiment, the hook element 96₂ is a bended rod generally configured to engage the corresponding latch 82 of the latch assembly element 72₂ of the front wall 52/52′/52″ (specifically, to engage the corresponding recess 84 of the latch 82 and to cause sliding movement of the latch 82 as the hook element 96₂ is engaged within the recess 84), which accordingly secures the front wall 52/52′/52″ to the side wall 54₂ and generally prevents or impedes movement of the front wall 52/52′/52″ relative to the side wall 54₂. The hook elements 96₁₋₂ may have any other suitable configuration in other non-limiting embodiments.

In this embodiment, the hook element 96₂ is generally positioned in an upper or top region of the front face of the side wall 54₂ (i.e., the hook element 96₂ is closer from a top surface 57 of the side wall 54₂ than from the bottom surface 55 of the side wall 54₂). As such, the side wall 54₂ is removably engageable with the cargo bed 58 via the lower surface 55 (or lower region) of the side wall 54₂, and is also removably engageable with the front wall 52/52′/52″ via the upper or top region of the side wall 54₂, thereby conferring a stability to the side wall 54₂ relative to the cargo bed 58 and the front wall 52/52′/52″ (i.e., a vertical and/or lateral stability of the side wall 54₂—it will be appreciated that this configuration enables an increased stability of the side wall 54₂ when compared to a configuration in which the side wall 54₂ is removably engageable with both the cargo bed 58 and the front wall 52/52′/52″ via the lower surface 55 (or lower region) of the side wall 54₂). The hook element 96₁ present on the side wall 54₁ may be similarly configured.

In further non-limiting embodiments, the hook element 96₁₋₂ may be provided in a lower region of the side wall 54₁₋₂ (in which case the hook element 96₁₋₂ is closer from the bottom surface 55 of the side wall 54₁₋₂ than from the top surface 57 of the side wall 54₁₋₂).

Still in this embodiment, the side wall 54₂ further comprises an alignment notch 94₂ configured to engage one of two recesses 100₁₋₂ of the front wall 52/52′/52″ (specifically the recess 100₂, the recess 100₁ being configured for engagement with corresponding alignment notch of side wall 54₁) to laterally and/or vertically position the side wall 54₂ relative to the front wall 52/52′/52″ during assembly of the side wall 54₂ (i.e., during positioning of the side wall 54₂ relative to the front wall 52/52′/52″ and the cargo bed 58). In this embodiment, the alignment notch 94₁₋₂ and corresponding recesses 100₁₋₂ are positioned in a lower region of the side wall 54₁₋₂ and front wall 52, respectively. In further non-limiting embodiments (including but not limited to when the hook elements 96₁₋₂ are provided in a lower region of the side wall 54₁₋₂), the alignment notch 94₁₋₂ and corresponding recesses 100₁₋₂ may be positioned in the upper or top region of the side wall 54₁₋₂ and front wall 52/52′/52″, respectively.

In yet further non-limiting embodiments, the position of the hook elements 96₁₋₂ and the latch assembly elements 72₁₋₂ may be switched between the front wall 52/52′/52″ and the side walls 54₁₋₂ (i.e., the front wall 52/52′/52″ may comprise the hook elements 96₁₋₂ and the side walls 54₁₋₂ may comprise the latch assembly elements 72₁₋₂).

Still in this embodiment, at least one of the side walls 54₁₋₂ and the front wall 52/52′/52″ may further comprise one or more accessory apertures 59 along a top surface thereof, the accessory apertures 59 being generally configured to receive a variety of accessories, such as but not limited to coolers, storage boxes, fuel tanks, storage bags and the likes.

The tailgate 56 is removably engageable with both the cargo bed 58 and the side walls 54₁₋₂ of the cargo box 50 using traditional engagement means, including in this embodiment hinges 110₁₋₂, positioned on respective lateral portions of the tailgate 56 and configured for removable engagement with the side wall 54₁₋₂. The tailgate 56 accordingly comprises a left tailgate portion 112 and a right tailgate portion 114, each one of the left and right tailgate portions 112, 114 being independently openable and removable by the user. In this embodiment, the tailgate 56, including the left and right tailgate portions 112, 114, is pivotally connected to the cargo bed 58 via a lower portion thereof, a pivot axis of the tailgate 56 relative to the cargo bed 58 extending generally laterally along a bottom surface of the tailgate 56. The tailgate 56, include the left and right tailgate portions 112, 114, can accordingly be moved from an open configuration to a close configuration, and vice versa, by pivoting the tailgate 56 relative to its pivot axis. In addition, the tailgate 56 is secured to each one of the side walls 54₁₋₂ of the cargo box 50 using any suitable mechanism, such as but not limited to clamps (toggle clamps), latches, handles, fasteners (quarter-turn fasteners), and the likes.

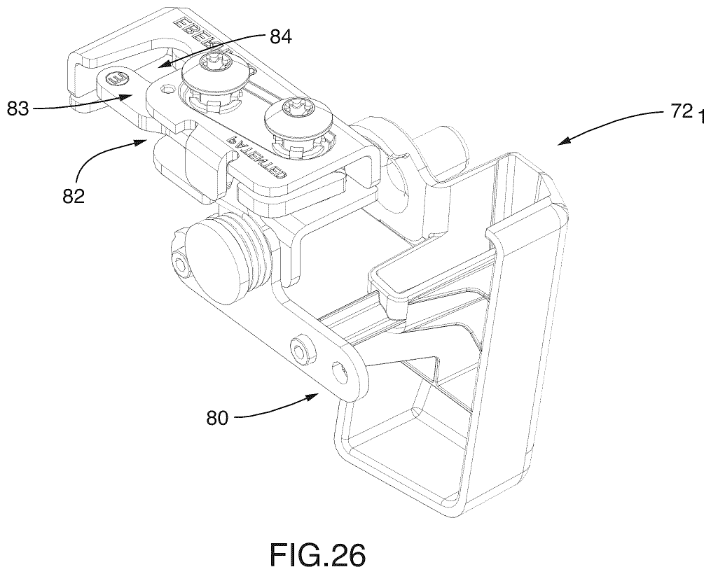

With further reference to FIGS. 26 to 29, a method for engaging the side walls 54₁₋₂ with the front wall 52/52′/52″ and the cargo bed 58, as well as removing the side walls 54₁₋₂ from the cargo box 50, is shown. As described above, as a result of the presence of the first connection mechanism with elements present on the side walls 54₁, 54₂, the front wall 52/52′/52″ and the cargo bed 58, the side walls 54₁₋₂ can be engaged and disengaged toollessly (i.e., without necessitating the use of tools or implements). Similarly, as a result of the presence of the first connection mechanism with elements present on the side walls 54₁, 54₂, the front wall 52 and the cargo bed 58, the front wall 52 can also be engaged and disengaged with the cargo bed 58 and the side walls 54₁₋₂ toollessly (i.e., without necessitating the use of tools or implements).

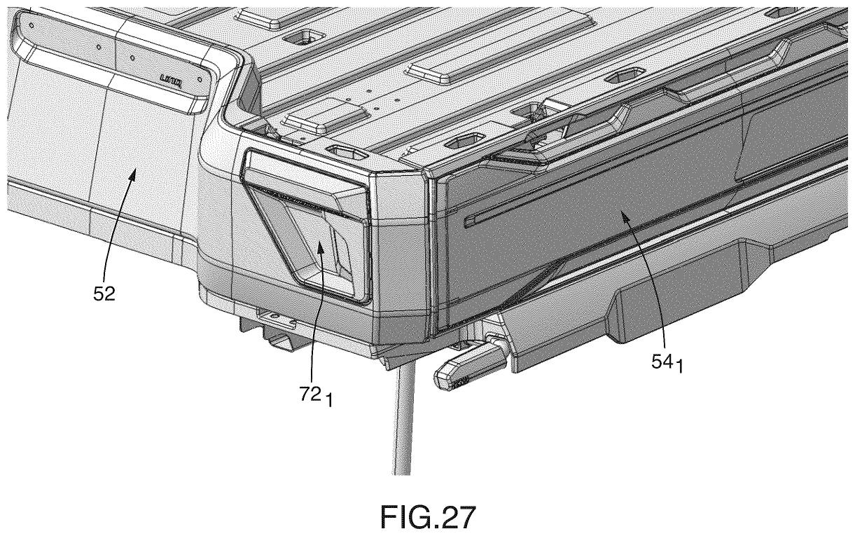

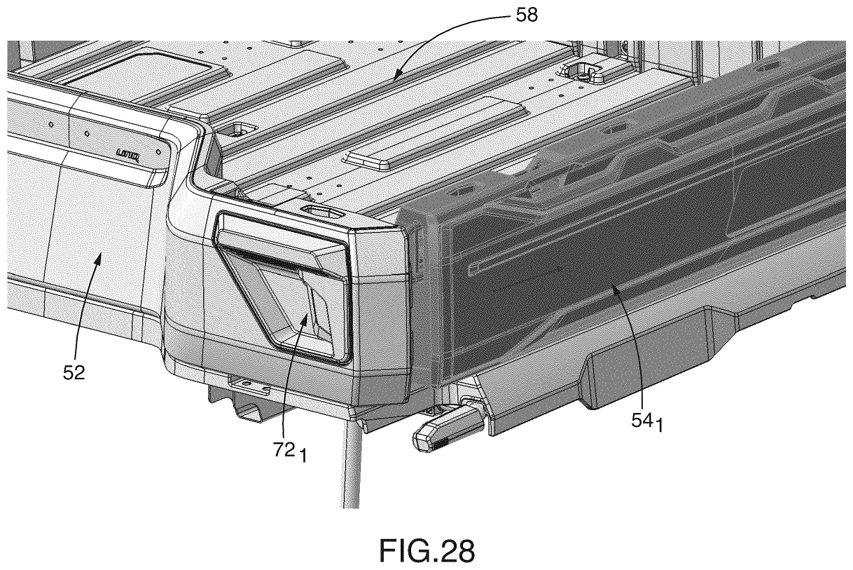

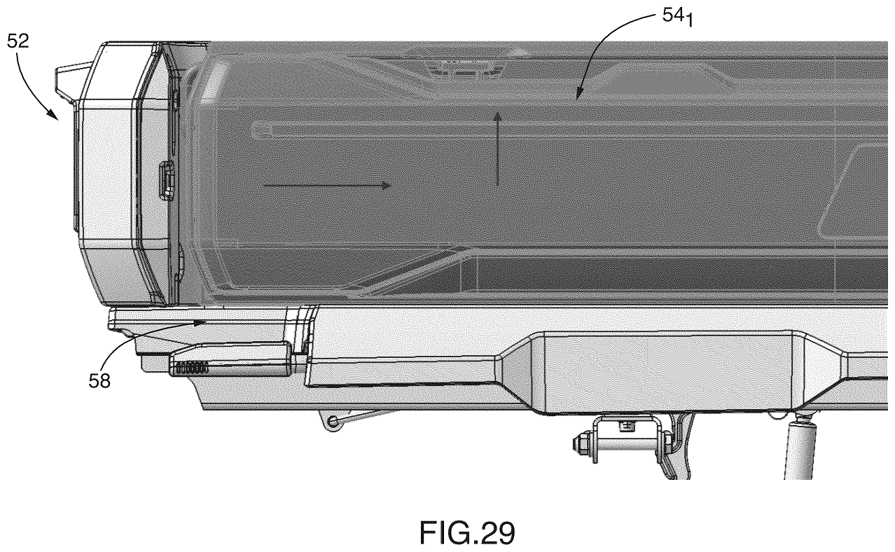

To disengage the side walls 54₁₋₂ from the cargo box 50, in a first step the tailgate 56 is removed from the cargo bed 58 or disengaged from the side walls 54₁, 54₂ and placed in an open (or horizontal) position by the user (not shown). In a second step, (FIG. 27) the user actuates the handle 80 of the latch assembly element 72₁ to open the latch 82 of the latch assembly element 72₁. In a third step (FIG. 28), the user slides the side wall 54₁ longitudinally and towards a rear edge of the cargo box 50, thereby releasing the hook element 96₁ from the recess 84 of the latch 82, until the side wall 54₁ is free to move upwards (i.e., when there is no interlocking engagement preventing a vertical movement of the side wall 54₁ relative to the cargo bed 58, for example when the hook element 96₁ is fully released from the recess 84 of the latch 82). In a fourth step (FIG. 29), the user moves the side wall 54₁ vertically upward relative to the cargo bed 58, thereby disengaging the side wall 54₁ from the cargo bed 58.

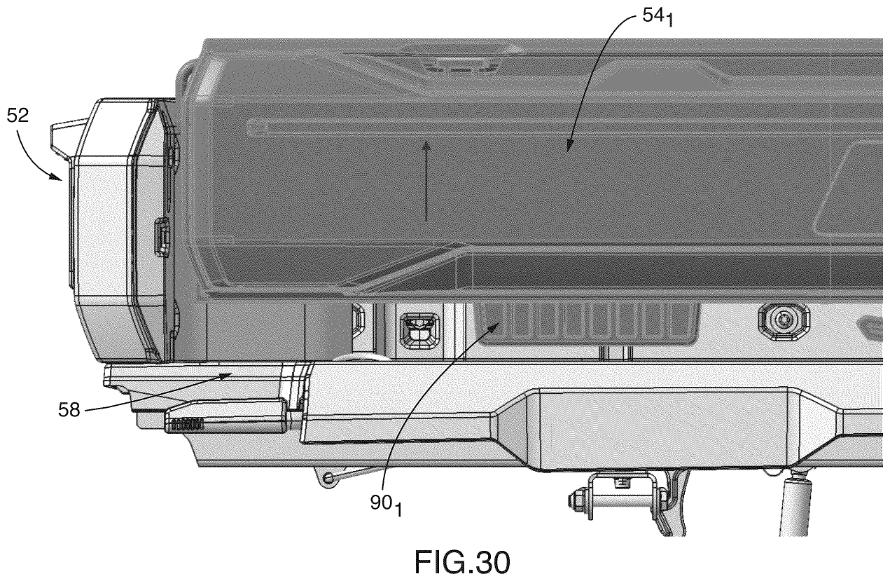

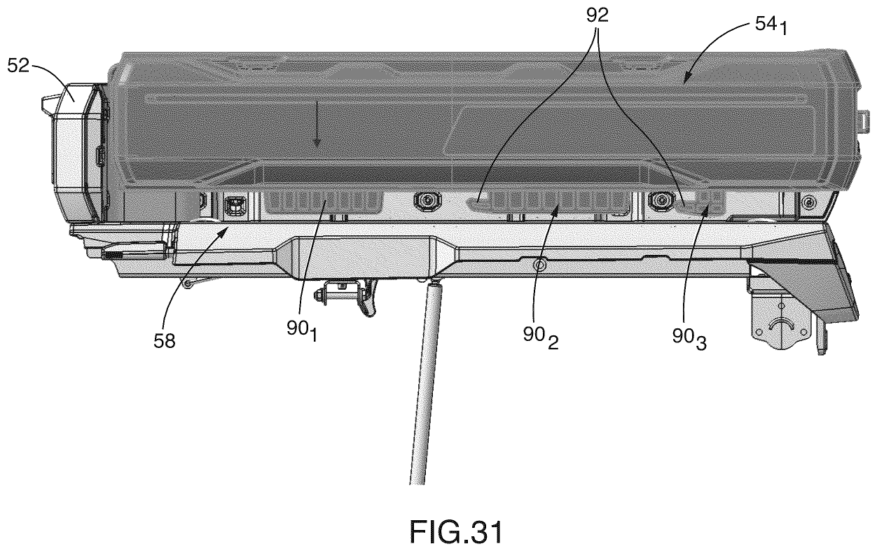

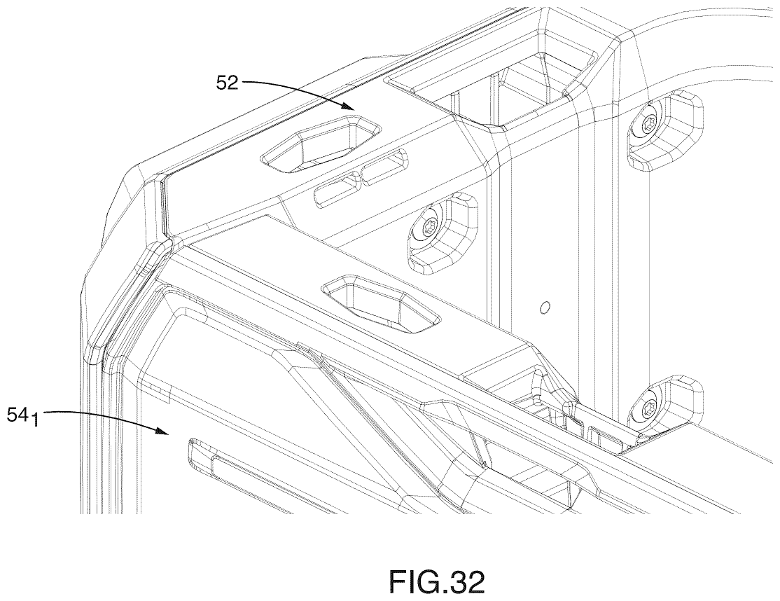

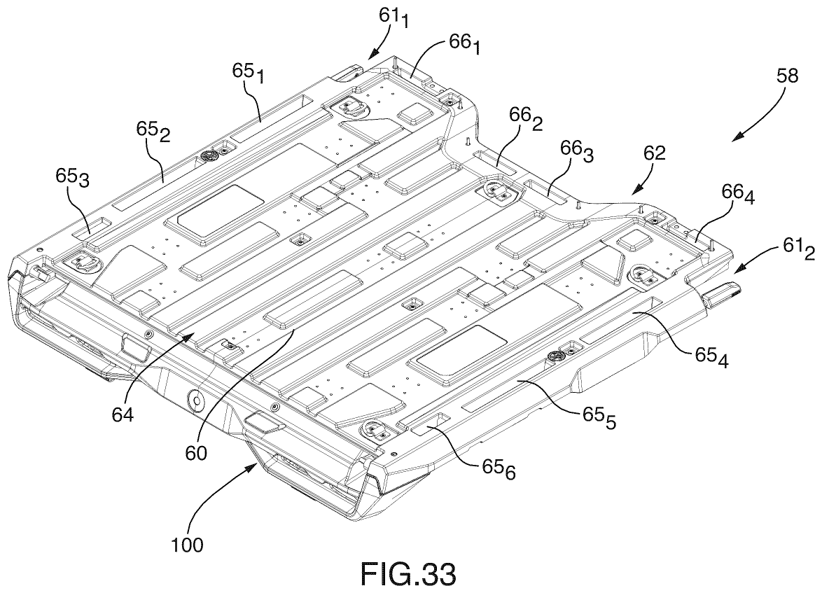

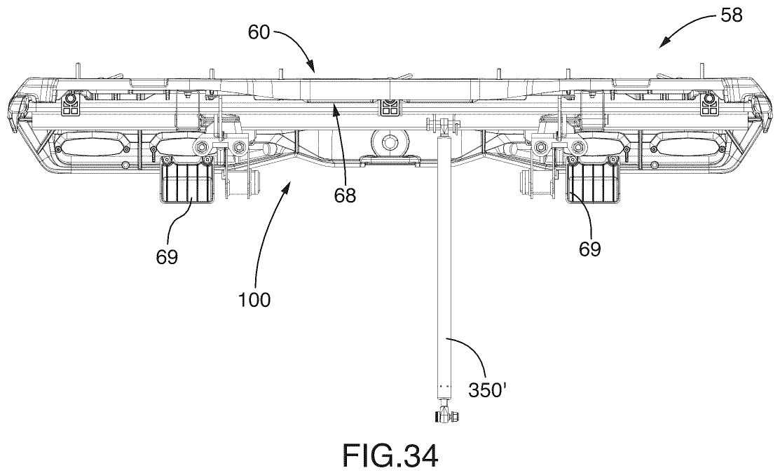

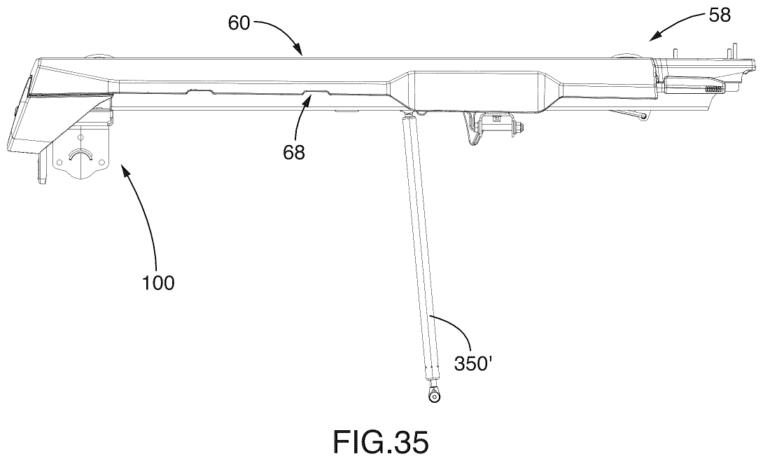

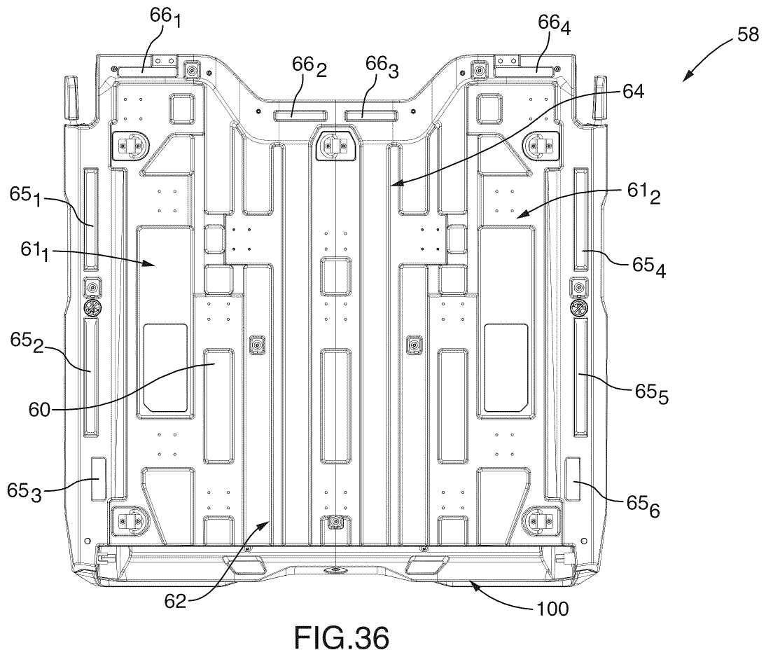

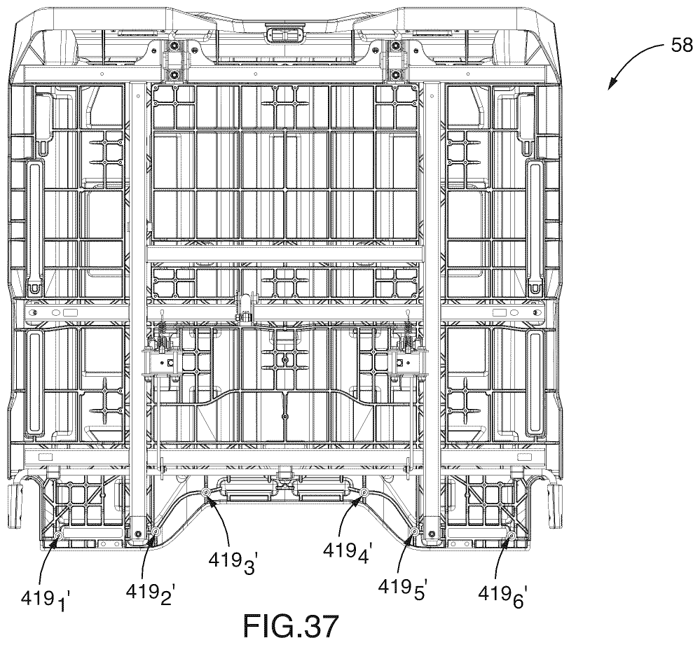

To engage the side walls 54₁₋₂ with the cargo bed 58, in a first step (FIG. 30) the user puts down the side wall 54₁ on the cargo bed 58 in an area behind the final position of the side wall 54₁ on the cargo bed 58. In a second step (FIG. 31), the user slides the side wall 54₁ towards a front region of the cargo box 50, and until the latch mechanism is engaged. In this embodiment, the attaching may not require an actuating action. In other embodiments, the handle 80 may need to be actuated during the second step.

As described above, as a result of the presence of the second connection mechanism with elements present on the front wall 52′/52″ and the cargo bed 58, the front wall 52′/52″ can be engaged with and disengaged from the cargo bed 58 using a plurality of tools or implements. To engage the front wall 52′/52″ with the cargo bed 58, in a first step, each one of the plurality of cleats 70′/70″ of the front wall 52′/52″ are aligned along the longitudinal and lateral directions with corresponding ones of the plurality of front apertures 66/66′ of the cargo bed 58. In a second step, the plurality of cleats 70′/70″ of the front wall 52′/52″ are engaged with corresponding ones of the plurality of front apertures 66/66′ by exerting a normal downward motion onto the front wall 52′/52″ relative to the cargo bed 58. In a third step, the plurality of removable fasteners 420′/1700′ are engaged with corresponding apertures 419₁₋₆′ of the cargo bed 58 and corresponding apertures (or recesses) 421₁₋₆′ present in the bottom portion of the front wall 52′/52″.

To disengage the front wall 52′/52″ from the cargo bed 58, in a first step the plurality of removable fasteners 420′/1700′ are removed from corresponding apertures 419₁₋₆′ of the cargo bed 58 and corresponding apertures (or recesses) 421₁₋₆′ present in the bottom portion of the front wall 52′/52″. In a second step, the plurality of cleats 70′/70″ of the front wall 52′/52″ are disengaged from corresponding ones of the plurality of front apertures 66/66′ of the cargo bed 58 by exerting a normal upward motion onto the front wall 52′/52″ relative to the cargo bed 58.

The cargo box 50 can be generally be configured by a user of the off-road vehicle 10 in a variety of distinct configurations. In a first configuration, the two side walls 54₁, 54₂, the tailgate 56 and the front wall 52/the front wall 52′ of the cargo box 50, respectively, are engaged with the cargo bed 58. In a second configuration, the two side walls 54₁, 54₂, the tailgate 56 and the front wall 52/the front wall 52′ of the cargo box 50, respectively, are not engaged with the cargo bed 58—this second configuration is also referred to as flat-bed configuration. It will be readily appreciated that, to achieve the first configuration, either the front wall can be engaged toollessly with the cargo bed 58, or the front wall can be engaged with the cargo bed 58 using a plurality of tools or implements, as described above.

In the previous description, non-limitative embodiments of the method are described. Although these embodiments of the assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the method, as will be briefly explained herein and as can be easily inferred herefrom by a person skilled in the art. Moreover, it will be appreciated that positional descriptions such as “above”, “below”, “left”, “right”, “bottom”, “top”, “end” and the like should, unless otherwise indicated, be taken in the context of the figures and should not be considered limiting.

Furthermore, in the previous description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

In the present description, an embodiment is an example or embodiment. The various appearances of “one embodiment”, “one embodiment”, “an embodiment” or “some embodiments” do not necessarily all refer to the same embodiment or embodiment. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments or embodiment is included in at least some embodiments, but not necessarily all embodiments.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

Several alternative embodiments, embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A cargo box for an off-road vehicle, the cargo box comprising:
a cargo bed;
a front wall;
a side wall; and
a tailgate,
wherein the side wall is configured for toolless removeable engagement with the cargo bed.

2. The cargo box claim 1, wherein the side wall comprises a plurality of cleats extending vertically from a lower surface of the side wall.

3. The cargo box of claim 1, wherein the cargo bed comprises a plurality of lateral apertures.

4. The cargo box of claim 3, wherein the plurality of lateral apertures are positioned on a lateral side portion of the cargo bed.

5. The cargo box of claim 4, wherein the plurality of lateral apertures have an elongated shape.

6. The cargo box of claim 4, wherein the plurality of lateral apertures are longitudinally spaced apart from each other on the lateral side portion.

7. The cargo box of claim 4, wherein at least one of the plurality of lateral apertures is laterally spaced apart from remaining one of the plurality of lateral apertures on the lateral side portion.

8. The cargo box of claim 4, wherein the plurality of cleats is configured for removeable engagement with at least some of the plurality of lateral apertures on the lateral side portion.

9. The cargo box of claim 1, wherein the cargo bed comprises a plurality of lateral recesses.

10. The cargo box of claim 1, wherein at least one of the plurality of lateral recesses is laterally spaced apart from remaining one of the plurality of lateral recesses on the lateral side portion.

11. The cargo box of claim 1, wherein the plurality of cleats is configured for removeable engagement with at least some of the plurality of lateral recesses on the lateral side portion.

12. The cargo box of claim 1, wherein the front wall is configured for removeable engagement with the side wall.

13. The cargo box of claim 1, wherein the cargo box further comprises a latch assembly.

14. The cargo box of claim 13, wherein the latch assembly is configured for preventing at least one of: (i) a movement of the side wall relative to the front wall; (ii) a movement of the side wall relative to the cargo bed; and (iii) a movement of the front wall relative to the side wall.

15. The cargo box of claim 14, wherein the latch assembly comprises a handle, a latch and a hook element.

16. The cargo box of claim 15, wherein the latch is configured to engage the hook element.

17. The cargo box of claim 16, wherein the handle is operable by a user to disengage the hook element from the latch.

18. The cargo box of claim 15, wherein the front wall comprises the handle and the latch and the side wall comprises the hook element.

19. A method for disengaging a side wall of a cargo box, the cargo box comprising a front wall, a cargo bed and a side wall, the method comprising:
actuating a handle of a latch assembly,
sliding the side wall longitudinally and towards a rear edge of the cargo box, and
moving the side wall vertically upward relative to the cargo bed.

20. A method for engaging a side wall of a cargo box, the cargo box comprising a front wall, a cargo bed and a side wall, the method comprising:
moving the side wall vertically downward relative to the cargo bed, and
sliding the side wall longitudinally and towards a front edge of the cargo box.
